(19) United States
(12) Patent Application Publication
(10) Pub. No.: US 2008/0108512 A1
(43) Pub. Date: May 8, 2008

(54) Method For The Site-Specific Synthesis Of Biopolymers On Solid Supports

(75) Inventors: Thomas Ellinger, Jena (DE); Eugen Ermantraut, Jena (DE); Nancy Hoizhey, Jena (DE); Frank Plenz, Jena (DE); Torsten Schulz, Jena (DE); Jens Tuchscheerer, Jena (DE); Daniel Weicherding, Munich (DE)

Correspondence Address: STEPTOE & JOHNSON LLP, 1330 CONNECTICUT AVENUE, N.W., WASHINGTON, DC, 20036, US

(73) Assignee: CLONDIAG CHIP TECHNOLOGIES GMBH, Jena (DE)

(21) Appl. No.: 11/667,116

(22) PCT Filed: Nov. 25, 2005
(86) PCT No.: PCT/EP05/12648

§ 371 Date: Dec. 18, 2007

(30) Foreign Application Priority Data
Nov. 25, 2004 (DE) 10 2004 056 980.0

(51) Int. Cl. C40B 40/06; C40B 50/14; C40B 40/10

(52) U.S. Cl. 506/16; 506/18; 506/30

(57) ABSTRACT

The present invention relates to methods for the site-specific synthesis of biopolymers such as nucleic acids or peptides and their respective derivatives on solid supports, wherein the local discrimination of the synthesis is performed by using masks that guide aqueous activating reagents for cleaving off protecting groups to predetermined regions on the support.

The present invention relates to methods for the site-specific synthesis of biopolymers such as nucleic acids or peptides of defined sequence in predetermined regions of a solid support. The present invention further relates to methods for the site-specific synthesis of biopolymers and their respective derivatives on solid supports, wherein the local discrimination of the synthesis occurs by using masks that guide aqueous activating reagents for cleaving off protecting groups to predetermined regions on the support. The methods according to the present invention are particularly suitable for manufacturing microarrays having molecular probes in form of biopolymers immobilized in predetermined regions.

Various methods are known for synthesizing biomolecules on solid supports in form of microarrays.

Methods for manufacturing microarrays in which predetermined regions of the support are activated by illumination are described, inter alia, in EP 0 619 321, EP 0 946 286, and U.S. Pat. No. 5,143,854. For performing said methods, which are also referred to as VLSIPS (very large scale immobilized polymer synthesis) methods, expensive photolabile protecting groups or photoactivatable catalysts as well as complex technical equipment are required.

Methods for manufacturing arrays using conventional synthesis chemistry are described in the following documents:

In U.S. Pat. No. 5,384,261, a method for synthesizing peptides is described, wherein rigid channel masks are employed that are placed on the support in order to separate specific regions provided for synthesis. In order to ensure an impermeable separation between said regions, the masks are screwed onto the surface of the support. One complete synthesis cycle is performed per channel.

In Nucleic Acid Res. 1992, 20, 1679-1684, U. Maskos and E. M. Southern describe a method for manufacturing a biopolymer array utilizing flexible masks. Silicone tubes that are pressed against the surface of the support are employed as mask material. Subsequently, synthesis cycles are performed in order to assemble the biomolecules on the array. However, the silicone tubes employed therein do not allow miniaturization.

In DE 195 43 232 and P. F. Xiao et al., Nanotechnology 2002, 13, 756-762, the site-specific deposition of activated phosphoramidite nucleosides on the surface of a support by means of a polydimethylsiloxane stamp is described. However, such a method is particularly not suitable for an efficient synthesis on rough or porous polymer surfaces. In said method, the regions of the support surface that have not been contacted by the stamp can also be contaminated during rinsing of the reagents after a stamping action is completed.

The derivatization of surfaces using polydimethylsiloxane stamps is also described in U.S. Pat. No. 5,512,131.

The use of stamps for immobilizing test substances as well as the subsequent processing of serological tests is, inter alia, also described in E. Delamarche et al., Science 1997, 276, 779-781; E. Delamarche et al., J. Am. Chem. Soc. 1998, 120, 3, 500-508 and A. Bernard et al., Langmuir 1998, 14, 9, 2225-2229.

The International Patent Application WO 97/33737 describes the exactly positioned deposition of chemical or biochemical substances by means of capillary forces using an object having a contoured surface.

In WO 98/36827, a method for generating substance libraries on a solid support using masks is described. In particular, a microstructured silicone membrane can be employed as mask. Said mask serves for covering defined regions of a support. The openings in the membrane or mask allow the performance of synthesis or immobilization steps in the uncovered regions of the support.

In U.S. Pat. No. 5,658,734, a method for synthesizing a multiplicity of chemical compounds of different structures on one support is disclosed, wherein a photoresist layer is utilized for covering specific regions on the support that is provided with labile protecting groups. The photoresist layer is exposed and developed. Subsequently, the labile protecting groups are removed from the regions that are not covered by the photoresist layer and a conventional synthesis cycle is performed for generating oligomers from amino acids, nucleotides, and the like. A similar method for immobilizing oligonucleotides is also described in U.S. Pat. No. 5,688,642.

However, such photoresist-based methods provide only poor yields and are reproducible only to a low extent. Thus, it is necessary to attach the photoresist on the support as sealingly as possible, as opposed to attempting to be able to easily remove the photoresist after completion of the synthesis cycle. It is a further problem that, during exposure and development, the photoresist that is applied onto the surface is subjected to chemical reactions that can affect the synthesis intermediates already located on the surface.

In U.S. Pat. No. 5,599,695, a method is described wherein methods that are conventional in printing are utilized for generating molecule libraries. Herein, a boundary layer is selectively applied onto the surface of a support in form of a liquid or of steam and thus a pattern for selectively attaching molecules to the support is generated. For example, silicone oil can serve as boundary layer. Cleaving off protecting groups is performed by means of gaseous deprotection reagents. Such an approach has the disadvantage that the liquid boundary layer material can also be permeated by a gaseous deprotection reagent. Furthermore, the precision of the method is limited by the possibility of blurring or merging of the reagents employed.

Thus, there is a need for methods for the site-specific synthesis of biopolymers having different sequences on a solid support that are cost-efficient, allow the use of reagents that are conventional for the synthesis of biopolymers, and ensure an efficient and accurate synthesis of the biopolymers. In particular, there is a need for methods for a site-specific synthesis of biopolymers having a local resolution in a μm-scale.

It is a problem underlying the present invention to overcome the previously mentioned difficulties of the prior art.

In particular, it is a problem underlying the present invention to provide a method for the site-specific synthesis of a multiplicity of biopolymer species having a sequence, for example a combinatory biopolymer library, that is in each case defined for a predetermined region, wherein reagents that are substantially conventional for the solid phase synthesis of biopolymers can be employed.

Furthermore, it is a problem underlying the present invention to provide a cost-efficient and simple method for the site-specific synthesis of a multiplicity of different biopolymers having a defined sequence.

Furthermore, it is a problem underlying the present invention to provide a method by means of which biopolymer libraries in form of microarrays can be applied onto a multiplicity of support materials.

It is a particular problem to provide a method in which masks that can be attached in an exactly positioned manner to the support material of a microarray can be employed in order to ensure the site-specific synthesis of the biopolymers.

It is a further problem underlying the present invention to provide a method for the site-specific synthesis of a multiplicity of biopolymers each having a defined sequence, wherein masks can be employed that can be removed from the support surface without affecting monomeric components that have already been attached to the support surface.

Finally, it is a problem underlying the present invention to provide a method for synthesizing a multiplicity of biopolymers having a defined sequence, wherein reagents can be used that are compatible with a mask material that meets the previously mentioned requirements and ensures a site-specific synthesis.

These and further problems underlying the present invention are solved by means of providing the embodiments characterized in the claims.

In particular, a method for the site-specific synthesis of biopolymers having a defined sequence on a solid support by gradually coupling monomeric and/or oligomeric building blocks is provided within the scope of the present invention, wherein prior to each coupling step temporary protecting groups for reactive groups on the support and/or at intermediates of the biopolymers to be synthesized are removed by adding an aqueous solution of an activating reagent.

A further object of the present invention is a method for the site-specific synthesis of biopolymers having a defined sequence in predetermined regions of a solid support by means of gradually coupling monomeric and/or oligomeric building blocks, wherein prior to each coupling step temporary protecting groups for reactive groups on the support and/or at intermediates of the biopolymers to be synthesized are removed by adding an aqueous solution of an activating reagent in at least one predetermined region.

A further object of the present invention is a method for the site-specific synthesis of biopolymers having a defined sequence in predetermined regions of a solid support comprising the following steps:
a) arranging a mask on the support, wherein on the support reactive groups that are available for coupling monomeric and/or oligomeric building blocks of the biopolymer to be synthesized are provided with protecting groups;
b) activating reactive groups by removing temporary protecting groups in the regions that are predetermined by the mask via the addition of activating reagent;
c) coupling a monomeric and/or oligomeric building block to reactive groups that have been activated in step b); and
d) repeating steps a) to c) until the desired biopolymers are synthesized in predetermined regions of the support.

A further object of the present invention is a method for the site-specific synthesis of biopolymers having a defined sequence in predetermined regions of a solid support comprising the following steps:
a) arranging an elastomer mask on the support, wherein on the support reactive groups that are available for coupling monomeric and/or oligomeric building blocks of the biopolymer to be synthesized are provided with protecting groups;
b) activating reactive groups by removing temporary protecting groups in the regions that are predetermined by the mask via the addition of activating reagent;
c) coupling a monomeric and/or oligomeric building block to reactive groups that have been activated in step b); and
d) repeating the steps a) to c) until the desired biopolymers are synthesized in predetermined regions of the support.

In a further aspect of the present invention, a microarray having biopolymer probes immobilized in predetermined regions is provided in which the percentage P of biopolymers having the desired number M of monomers is characterized by the formula P=S^{M}, wherein S is the average yield per coupling of a monomeric and/or oligomeric building block and wherein the density of predetermined regions is, for example, at least 1,500 spots per cm² and the average yield S is more than 94%, for example at least 95%, preferably at least 97%, particularly preferably at least 98%, and most preferably at least 98.6%.

A further aspect of the present invention relates to the use of the methods according to the present invention for manufacturing a microarray having biopolymer probes immobilized in predetermined regions of a support.

Finally, a further object of the present invention is the use of deprotection reagents in aqueous solution for cleaving off temporary protecting groups in the synthesis of biopolymers.

Currently, non-aqueous aprotic solvents are used in performing activation or deprotection reactions in biopolymer syntheses, as these do not lead to shrinking of swollen polymeric support materials, like they are, for example, used in peptide synthesis, and, on the other hand, quickly dry with the use of porous or rough supports. In both polynucleotide and peptide synthesis, the coupling steps are currently performed without the addition of water. In the synthesis of nucleic acids this was, inter alia, justified by the fact that water, being the stronger nucleophile, would hydrolyze the activated amidites that are employed in the nucleic acid synthesis. In the synthesis of peptides, hydrolysis of the active amino acid esters is slowed down under exclusion of water. In general, in performing condensation reactions such as polynucleotide or peptide syntheses that proceed while cleaving off water, it has hitherto been presumed that avoiding water as educt is to be preferred.

Surprisingly, it has now been found that the methods according to the present invention for synthesizing biopolymers on solid supports can be performed using aqueous activation or deprotection reagents without a significant effect on synthesis efficiency.

In the methods according to the present invention, substantially only one species of biopolymers, i.e. biopolymers having an identical sequence of monomers and an identical sequence length, are generated in a predetermined region of a support. Biopolymers in different predetermined regions can differ from monomers with respect to their sequences. The number of different biopolymer species on the support can be adjusted as desired, for example by selecting and arranging suitable masks, and is limited merely by the number of predetermined regions. In the extreme case, after completion of the method according to the present invention the number of predetermined regions on the support corresponds to the number of different biopolymer species on the support.

In case the local discrimination of the synthesis is performed by using masks, it is a prerequisite for ensuring a high degree of purity of a biopolymer species that is synthesized in a predetermined region of the support that the mask can be attached in a manner that is sealing in such a way that protecting groups are only removed in those regions that are predetermined by the mask, i.e. not in the regions that are covered by the mask. The use of aqueous activation or deprotection reagents has the considerable advantage that it enables the use of masks consisting of elastomers and that an alteration of the geometrical shape or a swelling of such a mask material, which results from the use of organic solvents, is thus avoided. Such a swelling of a mask consisting of elastomers would lead to a reduction of the adhesive forces that act between mask and support, even to a detachment of the mask from the support, and would thus result, inter alia, in contaminations in covered regions of the support.

The use of masks consisting of elastomers is advantageous as no external force, such as by means of screwing or clamping, is required in order to align the mask sealingly on the surface of the support. Thus, the mask is preferably sealingly attached onto the support surface merely by means of adhesion between the support material and the mask material. The mask is usually aligned with the marks that are attached on the support surface.

The methods according to the present invention can be performed with a multiplicity of support materials and, in particular, with all conventional support materials. Examples of suitable support materials are glass and silica. In particular, such combinations of mask and support materials are suitable for the methods according to the present invention that ensure a sufficient adhesion between support and mask in such a way that the mask can be arranged on the support in a sealing manner without the influence of an external force.

Furthermore, the methods according to the present invention for synthesizing a multiplicity of biopolymer species in predetermined regions of a solid support have the advantage that those reagents that are conventionally used in the solid phase synthesis of biopolymers can be employed. The disadvantages connected with UV illumination of the VLSIPS methods for manufacturing microarrays described in the art can thus be avoided.

Furthermore, the methods according to the present invention enable a high degree of parallelization, so that in predetermined regions of a solid support a multiplicity of biopolymer species having different sequences can be synthesized in parallel and in a site-specific manner.

In order to describe the present invention, the following definitions are used:

Within the scope of the present invention, a probe or a probe molecule or a molecular probe is understood to denote a molecule, in particular a biopolymer, that is used for detecting other molecules by means of a specific characteristic binding behavior or a specific reactivity. The probes arranged on the support, in particular in form of an array, can be any type of molecules that can be coupled to solid surfaces and have a specific affinity. In a preferred embodiment, the biopolymer probes are biopolymers from the classes of peptides, proteins, antigens, antibodies, carbohydrates, nucleic acids and/or analogs thereof and/or mixed polymers of the previously mentioned biopolymers. Particularly preferably, the probes are nucleic acids and/or nucleic acid analogs.

In particular, nucleic acid molecules of defined and known sequence are referred to as probes, which are used for detecting target molecules such as nucleic acids or members of other substance classes that bind to nucleic acids in hybridization methods. Both DNA and RNA molecules can be used as nucleic acids. The nucleic acid probes or oligonucleotide probes can be, for example, oligonucleotides having a length of 10 to 100 bases, preferably 15 to 50 bases, and particularly preferably of 20 to 30 bases. Typically, according to the present invention, the probes are single-stranded nucleic acid molecules or molecules of nucleic acid analogs, preferably single-stranded DNA molecules or RNA molecules having at least one sequence region that is complementary to a sequence region of the target molecules. Depending on detection method and application, the probes or biopolymers can be immobilized on a solid support substrate, for example in form of a microarray. Furthermore, depending on the detection method, they can be labeled, so that they are detectable by means of a conventional detection reaction.

Within the scope of the present invention, a target or a target molecule is understood to denote the molecule to be detected by means of a molecular probe. In a preferred embodiment of the present invention, the targets to be detected are nucleic acids. However, a microarray manufactured according to the present invention can also be employed analogously for detecting peptide/probe interactions, protein/probe interactions, carbohydrate/probe interactions, antibody/probe interactions etc.

In case the targets are nucleic acids or nucleic acid molecules that are detected by means of a hybridization against biopolymer probes arranged on a probe array within the scope of the present invention, said target molecules usually comprise sequences having a length of 10 to 10,000 bases, preferably of 15 to 2,000 bases, also preferably of 15 to 1,000 bases, in particular preferably of 15 to 500 bases and most preferably of 15 to 200 bases. Further examples of preferred sequence lengths are 20, 30, or 60 bases. Optionally, their sequences contain the sequences of primers as well as those sequence regions of the template that are defined by the primers. In particular, the target molecules can be single-stranded or double-stranded nucleic acid molecules one or both strands of which are labeled, so that they can be detected in a conventional detection method.

According to the present invention, the sequence region of the target that is detected by means of hybridization with the probe is referred to as target sequence. According to the present invention, this is also referred to as said region being addressed by the probe.

Within the scope of the present invention, a substance library is understood to denote a multiplicity of different probe molecules, preferably at least two to 1,000,000 different molecules, particularly preferably at least 10 to 10,000 different molecules, and most preferably between 100 to 1,000 different molecules. In special embodiments, a substance library can also comprise only at least 50 or less or at least 30,000 different molecules. Preferably, the substance library is arranged on a support in form of an array.

Within the scope of the present invention, a probe array or biopolymer array is understood to denote an arrangement of molecular probes or of biopolymers or of a substance library on a support, wherein the position of each probe is determined separately. Preferably, the array comprises defined sites or predetermined regions, the so-called array elements, which are particularly preferably arranged in a specific pattern, wherein each array element normally contains only one species of probes. Herein, the arrangement of the molecules or probes on the support can be generated by covalent or non-covalent interactions. The probes are arranged on that side of the support that is facing the reaction chamber. A position within the arrangement, i.e. within the array, is usually referred to as spot.

Within the scope of the present invention, an array element or a predetermined region or a spot or an array spot is understood to denote an area that is determined for depositing a species of molecular probes on the surface of a support. A species of molecular probes is biopolymers having the same sequence of monomers. The entirety of all occupied array elements is the probe array. Thus, according to the method of the present invention, substantially only one species of biopolymers is present in a predetermined region of the support after completion of the synthesis. In a particularly preferred embodiment, the spot has a square shape. The side length of such a square spot is preferably about 2 μm to about 128 μm, particularly preferably about 32 μm.

Within the scope of the present invention, a support element or a support or a substance library support or a substrate is understood to denote a solid body on which the biopolymers can be synthesized, preferably in form of a probe array or a biopolymer array. The support, which is conventionally also referred to as matrix, object support or wafer, can be made of silicon, silica, glass, synthetic materials, ceramics, glass ceramics, or quartz. The support, for example consisting of the previously mentioned materials and/or further conceivable materials, can be coated, for example with polymers. The layer can, for example, be generated from a gaseous, liquid, dissolved, or solid original state of the material to be applied. In case the support has such a layer, for example a polymer layer, it will also be referred to as substrate within the scope of the present invention.

The entirety of molecules or biopolymers that are arranged or synthesized in an array arrangement on the support or substrate or the substance library arranged or synthesized in an array arrangement on the substrate or the detection area and the support or substrate is also often referred to as “chip”, “biochip”, “microarray”, “DNA chip”, “probe array”, etc.

Conventional arrays or microarrays within the scope of the present invention comprise about 2 to 10,000, preferably 10 to 2,000, and particularly preferably at least 50 or at least 150 spots on a preferably square area of, for example, 1 mm to 5 mm×1 mm to 5 mm, preferably of 2 mm×2 mm or 3 mm×3 mm or 4.5 mm×4.5 mm or about 17.64 mm². Each of the spots has a defined species of probe molecules or biopolymers. Usually, each of the spots of an array has a different species of probe molecules or biopolymers. Conventionally, an array also comprises redundant spots, however, i.e. spots having the same species of probe molecules.

In further embodiments, microarrays within the scope of the present invention comprise about 50 to about 80,000, preferably about 100 to about 65,000, particularly preferably about 1,000 to about 10,000 spots or species, preferably different species, of probe molecules on an area of several mm² to several cm², preferably about 1 mm² to 10 cm², particularly preferably about 2 mm² to about 1 cm², and most preferably about 4 mm² to about 25 mm². A conventional microarray, for example, has 2 to 65,000 spots or, preferably different, species of probe molecules on an area of about 4.2 mm×4.2 mm. Further exemplary sizes of the areas of the microarray or the areas for the synthesis of the biopolymers are about 1 to 10 mm×about 1 to 10 mm, preferably about 2 to 5 mm×about 2 to 5 mm, and particularly preferably about 3.5 to 4.5 mm×about 3.5 to 4.5 mm. Within the scope of the present invention, the information on area and/or density usually refers to the base area of the microarray. The base area of a microarray results from the side lengths of the microarray. A microarray having an area of, for example, 4.2 mm×4.2 mm thus has a square base area of 17.64 mm 2 and a side length of 4.2 mm.

Within the scope of the present invention, a label or a marker is understood to denote a detectable unit, for example a fluorophore or an anchor group, to which a detectable unit can be coupled.

Within the scope of the present invention, the sample or sample solution or analyte is understood to denote the liquid to be analyzed containing the target molecules to be detected and, optionally, to be amplified.

Within the scope of the present invention, a molecular interaction or an interaction is, in particular, understood to denote a specific covalent or non-covalent bond between a target molecule and an immobilized probe molecule. In a preferred embodiment of the present invention, said interaction between probe and target molecules is a hybridization.

The formation of double-stranded nucleic acid molecules or duplex molecules from complementary single-stranded nucleic acid molecules is referred to as hybridization. An association preferably always occurs in pairs of A and T or G and C. Preferably, an association can also occur via non-canonical base pairings. The latter is understood to denote base pairings with non-canonical bases or nucleotides, whose nucleobase is derived from the basic pyrimidine or purine structure but has a different pattern of hydrogen bond donors or acceptors. Thereby, nucleobases, such as xanthine or hypoxanthine, are rendered capable of forming stable base pairings, so-called wobble base pairings, with different canonical bases. For hypoxanthine or its nucleoside inosine, stable pairing complexes with the nucleosides cytidine, adenosine, or thymidine are known. In this system, the individual base pairings show a graduated stability. The incorporation of non-canonical bases enabling wobble base pairings with the target sequences to be analyzed into probe sequences at the sites of a possible point mutation of a target sequence to be analyzed enables the detection of alleles of said target sequence by means of a probe species, in case their detection is supposed to be performed irrespective of the presence of the point mutation. Moreover, the incorporation of non-canonical nucleotides into a probe sequence is particularly advantageous in areas of spacer regions between highly conserved regions of the probe sequence that are responsible for addressing a target.

Within the scope of a hybridization, for example DNA-DNA duplexes, DNA-RNA duplexes, or RNA-RNA duplexes can be formed. Via hybridization, duplexes with nucleic acid analogs can also be formed, such as DNA-PNA duplexes, RNA-PNA duplexes, DNA-LNA duplexes, and RNA-LNA duplexes. Hybridization experiments are usually employed in order to detect the sequence complementarity and thus the identity between two different nucleic acid molecules.

Within the scope of the present invention, biopolymers are understood to denote synthetically generated polymers that are formed via polymerization reactions and contain identical or similar building blocks or monomeric building blocks such as naturally-occurring macromolecules, e.g. nucleic acids, polysaccharides, or peptides or proteins. Preferably, the biopolymers are peptides, proteins, antigens, antibodies, carbohydrates, nucleic acids and/or analogs thereof and/or mixed polymers of the previously mentioned biopolymers.

Within the scope of the present invention, a species of biopolymers is understood to denote biopolymers having an identical sequence, i.e. having an identical sequence of monomers, and having the entire desired length, i.e. number of monomers.

Within the scope of the present invention, substantially only one species of biopolymers is understood to denote a specific degree of purity of biopolymers having an identical sequence, i.e. also having the entire length, in a predetermined region. Thus, for example in case of a polymer length of 10 to 30, preferably of 15 to 25, and particularly preferably of about 20, substantially only one species of biopolymers is understood to denote a degree of purity of biopolymers having an identical sequence in a predetermined region of at least about 10% or at least about 30%, preferably of at least about 50%, and particularly preferably of at least about 75%. In particular, the degree of purity or the degree of purity P or the percentage P is determined by the formula P=S^{M}, wherein S is the average yield per coupling of a monomeric and/or oligomeric component, wherein the average yield S is at least 90%, preferably at least 97%, particularly preferably at least 98%, and most preferably at least 99%.

Within the scope of the present invention, monomers or monomeric components are understood to denote all compounds from which biopolymers can be constructed via polymerization reactions. Within the scope of the present invention, a monomer is understood to denote a component that is capable of forming one or more constitutional units whose (multiple) repetition in form of constitutional repetition units yields a biopolymer. Constitutional units or monomers in the case of biopolymers are, for example, nucleotides and amino acids.

Within the scope of the present invention, an oligomer or an oligomeric component is understood to denote a sequence of monomers that preferably represents a partial sequence of the biopolymers to be synthesized. The oligomers that are employed in the method according to the present invention can be provided by means of classical solid phase synthesis as described for peptides and oligonucleotides.

Within the scope of the present invention, a reactive group or functionality is understood to denote a functional group of the support or of a monomeric or oligomeric building block that enables a coupling reaction, in particular a condensation reaction, with the respective reactive group of a further monomeric or oligomeric building block or with the support. Reactive groups of amino acid building blocks are particularly amino and carboxyl groups. Reactive groups of nucleotide building blocks are particularly hydroxyl and phosphate or phosphoric esters or activated phosphoric ester groups such as phosphotriester and/or phosphoramidite groups.

A monomeric or oligomeric building block employed in the methods according to the present invention has at least two reactive groups, one of which serves for coupling to free reactive groups that are present on the support surface or to intermediates of the biopolymers to be synthesized that have free reactive groups, and the other for coupling a further monomeric or oligomeric building block in the subsequent coupling step.

In a coupling step in the methods according to the present invention, monomeric or oligomeric building blocks are usually employed in which the reactive group serving for coupling to the support surface or to intermediates of the biopolymers to be synthesized is free, i.e. is not provided with a protecting group, while the reactive group serving for coupling a further monomeric or oligomeric building block in the subsequent coupling step is protected by a protecting group, in particular by a temporary protecting group.

Reactive groups that are available on the support for coupling monomeric and/or oligomeric building blocks of the biopolymer to be synthesized are understood to denote reactive groups or functionalities with which the support is provided and that serve for coupling the first monomeric or oligomeric building block. In case the synthesis is already in an advanced stage, reactive groups that are available on the support for coupling monomeric and/or oligomeric building blocks of the biopolymer to be synthesized are understood to denote functionalities or reactive groups of the intermediate of the biopolymer to be synthesized that serve for coupling further monomeric and/or oligomeric building blocks.

Within the scope of the present invention, an intermediate or intermediate product of the biopolymer to be synthesized is understood to denote a polymer chain consisting of monomeric building blocks that is already immobilized or synthesized on the support and corresponds to a partial sequence of the desired biopolymer. An intermediate is present after the performance of at least one coupling step, i.e. the coupling of at least one monomeric and/or oligomeric building block to the support.

Within the scope of the present invention, a coupling step comprises activating or deprotecting a reactive group for coupling a monomeric or oligomeric building block, the actual coupling reaction between reactive group and monomeric or oligomeric building block as well as, optionally, the subsequent capping of the coupled monomeric or oligomeric building block. Within the scope of the present invention, the yield S is understood to denote the yield of a coupling step.

Within the scope of the present invention, the residues by means of which it is possible to temporarily protect specific functional groups of a molecule containing one or more reactive centers, for example of a monomer, and/or functional groups on the support surface against the attack of reagents, so that reactions such as condensations of monomeric or oligomeric building blocks will only occur at the desired (unprotected) sites. In particular, numerous protecting groups for amino and carboxy groups of amino acids have been developed that are supposed to react with one another exclusively utilizing their unprotected functional groups to form peptides or proteins in order to deliver yields as large as possible. Analogous protecting groups are also conventional in polynucleotide synthesis.

Examples of temporary protecting groups in the peptide synthesis are the acid-labile Boc-(tert.-butyloxycarbonyl) and the base-labile Fmoc-(fluorenyl-9-methoxycarbonyl) group. Examples of temporary protecting groups in the polynucleotide synthesis are the acid-labile DMT-(dimethoxytrityl) group and photolabile protecting groups as described, inter alia, in U.S. Pat. No. 5,744,305.

Within the scope of the present invention, permanent protecting groups are understood to denote such residues that are capable of protecting specific functional groups of the monomeric building blocks against the attack of reagents during the entire course of the synthesis, so that reactions such as condensations of monomeric or oligomeric building blocks will only occur at the desired (unprotected) sites. Such permanent protecting groups serve for protecting functional groups in the side chains of amino acid residues or nucleobases and are preferably cleaved off only after completion of the biopolymer synthesis.

Examples of permanent protecting groups in the peptide synthesis are the Z-(benzyloxycarbonyl) and the Bzl-(benzyl) group. Examples of permanent protecting groups in the polynucleotide synthesis are the Bz-(benzoyl), the iBu-(isobutyryl) and the TBDMS-(t-butyldimethylsilyl) group.

Further temporary and permanent protecting groups are described in H.-D. Jakubke, Peptide—Chemie und Biologie, Spektrum Verlag, Heidelberg, Berlin, Oxford, 1996.

Within the scope of the present invention, an activating reagent is understood to denote a reagent that releases or generates functional groups of a molecule, for example of a monomeric or oligomeric building block, so that reactions such as condensations with further monomeric or oligomeric building blocks can occur at the released or generated functional groups. Within the scope of the present invention, activating reagents are deprotection reagents.

Within the scope of the present invention, a deprotection reagent is understood to denote a reagent that is suitable for specifically removing protecting groups from reactive groups, so that reactions such as condensations of monomeric or oligomeric building blocks can occur at the desired (unprotected) reactive groups.

Exemplary deprotection reagents, in particular for cleaving off acid-labile protecting groups, are methanesulfonic acid, oxalic acid, trifluoromethanesulfonic acid and/or mineral acids such as hydrochloric acid. Within the scope of the present invention, the activating or deprotection reagents are preferably employed in aqueous solution. Thus, about 2% to about 40% aqueous solutions, preferably about 5% to about 35% aqueous solutions and particularly preferably about 10% aqueous solutions of activating or deprotection reagents such as methanesulfonic acid, oxalic acid, trifluoromethanesulfonic acid and/or mineral acids can be employed in the methods according to the present invention. The person skilled in the art is easily capable of determining the correlation between the concentration of the deprotection reagent and the duration of the deprotection reaction. Thus, for example, 10% aqueous solutions of oxalic acid or methanesulfonic acid are particularly preferably employed in the methods according to the present invention for activating nucleic acids that are protected by DMT. For instance, in the synthesis of polypeptides, it is furthermore possible to use stronger acids than in the synthesis of nucleic acids, as in this case, as opposed to the synthesis of nucleic acids, no side reactions such as depurination will occur.

Within the scope of the present invention, a mask is understood to denote a solid material that is provided with hollow spaces, recesses or islands and/or channels, so that, when arranging the mask on the support surface, those regions of the support that are predetermined by the hollow spaces, recesses and/or channels are accessible for the biopolymer synthesis or for the addition of reagents such as activating reagents, while the regions that are covered by the mask are not accessible for reagents due to the sealing arrangement of the mask on the support. In particular, those regions that are predetermined by the mask, i.e. the regions that are not covered by the mask, are identical to predetermined regions of the support that have been selected for synthesizing a species of biopolymers. Alternatively, in case inert regions or inert bridges are arranged, for example, between the spots, the regions that are covered by the mask can have a different geometry than the spots. In this case the regions that are covered by the mask can thus have, for example, rectangular geometries while the geometries of the spots on the support are, for example, circular. Usually, the masks that are employed in the methods according to the present invention have at least one opening for filling with and draining of reagents.

A mask that is employed within the scope of the present invention does not react with the biopolymers or biopolymer intermediates that are synthesized on the support surface. Such a mask is furthermore suitable for being attached onto the support surface in such a way that the mask material rests on the support surface in a sealing manner.

Preferably, the masks have one, preferably more, channels that are provided with a supply and drain and have a width of about 2 μm to about 2 mm or about 2048 μm, particularly preferably of about 10 μm to about 512 μm, and most preferably of about 32 μm to about 128 μm. The channels are usually linear, wherein the length of a linear channel at least corresponds to the length of an array.

Such a channel can have one or more islands, wherein the channel widths are preferably larger than the widths of the respective islands. Particularly preferred in this case are channels whose widths correspond to the active area of the respective chip and that have, for example, a width of about 2048 μm. In particular, the islands have a length and/or width of about 2 μm to about 2 mm, particularly preferably of about 10 μm to about 512 μm, and most preferably of about 32 μm to about 128 μm.

Within the scope of the present invention, elastomers are understood to denote polymers that exhibit a rubber-elastic behavior, that can be repeatedly stretched to at least twice their length at room temperature and that immediately resume their approximate original length after discontinuation of the force that is required for stretching (see, for example, DIN 7724). Examples for elastomers are silicone elastomers, such as PDMS (polydimethylsiloxane) and rubber derivatives.

Within the scope of the present invention, an elastomer mask or a mask consisting of elastomers or a mask comprising elastomers is understood to denote a mask in which at least the side of the mask contacting the support is provided with a layer consisting of one or more elastomers.

Within the scope of the present invention, an impermeable or sealing connection between mask and support is understood to denote that the mask rests on the support in such a way that the reagents that are, for example, supplied via the channels of the mask, preferably in solution, into the regions that are not covered by the mask do not reach the regions of the support that are covered by the mask.

Within the scope of the present invention, derivatizing the support is understood to denote that the support surface is provided with functional groups that ensure the coupling of spacers or linkers and/or monomeric components. Preferably, derivatizing the support is performed by applying a polymer onto the support, wherein the polymer is provided with functional groups that ensure the coupling of linkers and/or monomeric components. The arrangement consisting of the support with a polymer layer applied thereon will also be referred to as substrate in the following.

In the case of a covalent coupling of the biopolymers to be synthesized or linkers or spacers, supports and/or polymers optionally applied onto said supports, for example silanes, are utilized that are functionalized or modified with reactive functionalities such as alkoxy, epoxide, halogenide, hydroxyl, amino, carboxyl, thiol, aldehyde and the like. Furthermore, the activation of a surface by means of isothiocyanate, succinimide esters and imido esters is also known to the person skilled in the art. To this end, amino-functionalized surfaces can correspondingly be derivatized. Furthermore, corresponding immobilizations of the biopolymers to be synthesized can be ensured by means of adding coupling reagents such as dicyclohexylcarbodiimide. In case the monomeric components to be attached onto the support or the substrate have amino groups that are intended for coupling to the support or the substrate, the support or the substrate is preferably derivatized with a compound bearing epoxide groups.

Within the scope of the present invention, linkers or spacers are understood to denote molecular groups that couple functional groups on the support surface with monomeric components of the biopolymer to be synthesized. The linkers or spacers that are employed within the scope of the present invention may have linear or branched chains. Preferred linkers or spacers are selected from polyethylene glycol and polymers functionalized with epoxide groups, such as epoxy-functionalized silanes. Branchings can, for example, be generated by means of polymer spacers or linkers comprising glycerol components.

Examples of linkers or spacers, in particular for coupling DNA to the support or the substrate, are polyethers (ROR′) such as mixed polymers from bisepoxide and polyethylene glycol, polyurethanes (RNHC(O)OR′) such as mixed polymers from alkoxy and diisocyanates and mixed polymers from aryloxy, alkoxy and diisocyanates, polythiocarbamates (RNHC(O)SR′) such as mixed polymers from alkoxy and diisothiocyanates and mixed polymers from bismercaptans and diisocyanates, and polydithiocarbamates (RNHC(S)SR′) such as mixed polymers from dithiol and diisothiocyanates. In case it is desired to provide a substrate surface having mercapto functions (RSH), epoxy-functionalized silanes and dithiols can be employed. For substrates having aminated surfaces (RNH₂), for example amino-functionalized silanes are utilized as linkers or spacers.

Thus, an object of the present invention is a method for the site-specific synthesis of biopolymers having a defined sequence in predetermined regions of a solid support by means of gradually coupling monomeric and/or oligomeric building blocks, wherein prior to each coupling step reactive groups that are available in at least one predetermined region of the support for coupling a monomeric and/or oligomeric building block are activated in that temporary protecting groups are removed from said reactive groups by means of adding an activating reagent in aqueous solution.

It is a characteristic feature of the methods according to the present invention that the site-specific synthesis of a multiplicity of biopolymer species each having a defined sequence in predetermined regions of a solid support is performed using aqueous reagents for activating reactive groups. The reactive groups are activated by means of cleaving off temporary protecting groups that are located at said reactive groups by means of deprotection reagents in aqueous solution. Preferably, the temporary protecting groups are removed from such predetermined regions of the support that are predetermined by a mask arranged on the support.

The methods according to the present invention allow the use of conventional reagents for synthesizing biopolymers and enable the synthesis of biopolymer substance libraries in array format on miniaturized supports. Thus, biopolymers synthesized in situ by methods according to the present invention can be employed particularly as molecular probes, in detection methods in array format. Herein, the microarray or biochip is formed by the support and the biopolymers synthesized in predetermined regions of the support.

The biopolymers to be synthesized are preferably selected from nucleic acids, peptides, and peptide nucleic acids. For example, selecting the biopolymers occurs depending on the use of a microarray that can be manufactured according to the methods of the present invention, and in which the biopolymers synthesized correspond to probe molecules for detecting target molecules in a sample to be analyzed.

The local discrimination of the synthesis in such a way that substantially only one species of biopolymers having identical sequences is present in a predetermined region of the support is ensured by the use of masks that guide the aqueous reagents for cleaving off the protecting groups to the regions that are predetermined by the mask in a directed manner. Thus, the site-specificity of the synthesis is achieved by means of a masking strategy in which the reagents for cleaving off the protecting groups, i.e. the activating or deprotection reagents, can only wet those regions on the surface of the support that are not covered by the mask due to the use of mechanical masks. The masks employed in accordance with the present invention do not only allow the provision of continuous channels, but optionally also the covering of individual predetermined regions or spots of the array.

By using the method according to the present invention that employs masks for manufacturing a microarray, the density of the spots on the support surface is predetermined by positioning and miniaturizing channels or hollow spaces of the masks. In this manner, it is possible to achieve a density of predetermined regions on the microarray of, for example, at least 1,500 spots per cm², preferably of at least 2,500 spots per cm², particularly preferably of at least 10,000 spots per cm², and most preferably of at least 25,000 up to one million spots per cm². The information on the density of spots usually refers to the base of the microarray, which in turn results from the side lengths of the microarray.

Said high densities of predetermined regions allow the provision of extremely small microarrays having a large number of spots. Thus, square chips having a side length of 1 cm or 1 mm, but also of only 0.1 mm, can be manufactured. In preferred embodiments, the support surface is at most 1 cm², at most 25 mm², at most 17.64 mm², at most 4 mm², at most 1 mm² or at most 100 μm².

Thus, a method according to the present invention in particular comprises the following steps:
a) arranging a mask on the support, wherein reactive groups that are available on the support for coupling monomeric and/or oligomeric building blocks of the biopolymer synthesized are provided with protecting groups;
b) activating reactive groups by means of removing temporary protecting groups in the regions that are predetermined by the mask by means of adding an activating reagent in aqueous solution;
c) coupling a monomeric and/or oligomeric building block to reactive groups that have been activated in step b); and
d) repeating steps a) to c) until the desired biopolymers are synthesized in predetermined regions of the support;

The activating or deprotection reagents are preferably selected from oxalic acid, methanesulfonic acid, trifluoroacetic acid, hydrochloric acid and/or sodium hydroxide, and are preferably employed in aqueous solution. By means of aqueous solutions of the previously mentioned activating reagents particularly preferred protecting groups such as dimethoxytrityl in polynucleotide synthesis and t-butyloxycarbonyl in peptide synthesis, can be removed.

It is obvious to the person skilled in the art which time period for the deprotection step is to be selected depending on the concentration of the respective reagent. Thus, a preferred duration of the deprotection reaction is, for example, about twenty minutes when using 10% oxalic acid and about five minutes when using 10% methanesulfonic acid.

Preferably, only cleaving off the protecting groups is performed using the mask, so that the remaining synthesis cycle for coupling a monomer can be performed in open form, i.e. without a mask, for example in a conventional synthesis chamber.

Preferably, mask and support material are selected in such a way that the mask that is arranged on the support is impermeably connected with the latter, for example in that the mask sticks to the support by means of adhesion.

Thus, the support is preferably selected from silicon, such as silica, glasses such as soda-lime glasses, borosilicate glasses, Borofloat glasses, for example BF 33 glass (Schott, Mainz, Germany), quartz glass, quartz, single-crystal CaF₂, sapphire discs, topaz and/or synthetic materials such as PMMA and/or polycarbonate, ceramics, Ta₂O₅, TiO₂, Si₃N₄ and/or Al₂O₃. Particularly preferably, the support consists of silicon or Borofloat glass.

Preferably, the masks employed consist of inert materials that do not participate in the biopolymer synthesis. The masks employed according to the present invention have the considerable advantage that they can be removed from the support material without influencing their functionality. Thus, they differ from the photoresist layers that have been described as mask material in the prior art and that can only be removed from the support by dissolving the layer.

Applying the mask onto the support leads to the formation of channels that are optionally provided with islands or of free spaces between the sites on which there does not rest any mask material. The activating or deprotection reagents can then flow into the free spaces, i.e. the mask serves for selective activation, in particular for selective deprotection.

The free or hollow spaces that are developed by such channels can have optional basic forms, such as square, rectangular, circular and the like. Such a hollow space can make several spots, for example two to ten spots, or only one spot or all of the spots, accessible for reagents.

When arranging the mask on the support, the mask and the support are positioned in relation to one another preferably with an exactness of a few μm, particularly preferably about 1.5 μm to about 3 μm, and most preferably about 1 μm to about 2 μm. The distances between the predetermined regions are thus considerably smaller than the distances in the spotting method, as in the latter method the drop size and the distances of the drops to one another are the limiting factors. Thus, the methods according to the present invention enable providing a substantially higher density of predetermined regions on the support.

Herein, positioning the mask on the support is preferably performed by means of marks that are attached to the support.

By shifting a mask in x, y-direction and/or rotating the mask by an optional angle of between 0° and 360°, a multiplicity of patterns can be generated on the support surface with a small number of masks. In this manner, microarrays having optional combinations of biopolymer probes can be developed.

Masks consisting of elastomers are preferably employed. Particularly preferred are masks consisting of polydimethylsiloxane. The use of elastomers ensures adhesion between support and mask without requiring an external force in order to connect the mask with the support in a sealing manner. It can also be preferred that only the side of the mask facing the support when using the method according to the present invention is made of elastomers. In this embodiment of the mask, such a layer consisting of elastomers is usually attached onto a solid base body, for example consisting of glass or synthetic material.

Thus, for example when using a polydimethylsiloxane mask, the mask is positioned on the support as accurately as possible and through contact of the polydimethylsiloxane mask with the synthesis surface of the support is joined in an adhesive and sealing manner. By connecting the support or wafer with the masks, which have geometric structures such as, channels with stamps or islands, corresponding hollow spaces are generated through which the deprotection reagent can flow and can thus activate the surface of the wafer for the subsequent synthesis step.

Furthermore, in a preferred embodiment of the present invention, a support having a rough surface is employed.

Such supports having a rough support surface have a variety of advantages, in particular in case the biopolymers produced according to the present invention are employed as probes in array experiments.

By providing a rough surface on the support, the number of potential immobilization sites for the biopolymers to be synthesized is increased. This leads to an increased dynamic measurement range as well as to an improved signal-to-noise ratio when performing detection methods using the microarrays manufactured according to the present invention. The use of supports having a rough surface thus enables an improved analysis of small sample amounts.

Furthermore, the accessibility of the synthesized biopolymers on a rough surface for the molecules to be analyzed is improved, whereby a faster and more complete interaction between the target and the probes, that is the synthesized biopolymers, is ensured. Furthermore, kinetic processes that proceed in microarray analysis, such as the supply of reagents, rinsing steps and the like, are considerably accelerated.

It is preferred that only the surfaces within the predetermined regions have a roughness and thus bridges are formed around the predetermined regions having smooth surfaces. Such bridges around the predetermined regions enhance the adhesive properties of the mask and thus ensure a sealing resting of the mask on the substrate surface.

The supports employed in the method according to the present invention are usually cleansed prior to the beginning of the synthesis. Cleaning is preferably performed according to the conventional protocols used for the respective support material. Cleaning can, for example, be performed with Caro's acid or with tetramethylammonium hydroxide solution.

Usually, the supports employed in the methods according to the present invention are also pretreated prior to performing the synthesis. Such a pretreatment of the support can be performed by derivatizing the support. Derivatizing the supports can be performed in that the surface side of the support that is available for the synthesis is provided with a polymer layer. Preferably, the polymer layer is made of silanes, gelatin and/or polyurethane. The thickness of such a layer that is attached onto the support is preferably about 1 nm to about 5 nm, particularly preferably about 2 nm to about 4 nm, and most preferably about 3 nm. The average contact angle of such a polymer layer is preferably about 40° to about 60° and particularly preferably about 50°. For manufacturing a silanized support, the support, for example a glass wafer, can be provided with glycidoxypropyltrimethoxysilane.

In a further preferred embodiment, in case supports that are provided with a polymer layer are employed in the method according to the present invention, said polymer layer is modified prior to the beginning of the biopolymer synthesis, in particular in order to provide a large number of functional groups, for example hydroxyl groups, for linking monomeric building blocks of the biopolymer to be synthesized. Such a modification can, for example, be performed by adding an acid, by adding linkers that bear hydroxyl groups, such as polyalkylene glycols, by modification with a three-dimensional polymer layer and/or by treatment with a resist layer.

Adding an acid for modifying a polymer layer that is applied on the support is advantageous in case the polymer layer of the support bears epoxide groups, for example in case the support is provided with a layer consisting of glycidoxypropyltrimethoxysilane. The acid, for example a strong acid such as sulfuric acid or hydrochloric acid, leads to the “opening” of epoxides. In this manner, diols are provided that are capable of reacting with suitable functionalities of the monomeric building block to be linked, such as phosphor esters or activated phosphor ester groups in the polynucleotide synthesis.

Alternatively, the polymers that are attached to the support can be modified by conversion with linkers bearing hydroxyl groups. Particularly preferred linkers are polyalkylene glycols such as polyethylene glycol, for example PEG200, polyethers (ROR′) such as mixed polymers from bisepoxide and polyethylene glycol, polyurethanes (RNHC(O)OR′) such as mixed polymers from alkoxy and diisocyanates and mixed polymers from aryloxy, alkoxy and diisocyanates, polythiocarbamates (RNHC(O)SR′) such as mixed polymers from alkoxy and diisothiocyanates and mixed polymers from bismercaptans and diisocyanates, and polydithiocarbamates (RNHC(S)SR′) such as mixed polymers from dithiol and diisothiocyanates as well as epoxy-functionalized silanes and dithiols that provide substrate surfaces having mercapto functions (RSH). Thus, in a particularly preferred embodiment, a support that is coated with glycidoxypropyltrimethoxysilane is modified by conversion with polyethylene glycol.

In a further embodiment of the modification, a support that is provided with a polymer layer is modified with a three-dimensional polymer layer. Such a three-dimensional polymer layer can, for example, be generated on the support that is already provided with a polymer layer, for example a silane layer, by in situ polymerization of a polyalkylene glycol such as polyethylene glycol using a crosslinker. Suitable crosslinkers are bisepoxides, such as bisglycidyloxypropylmethane.

Such a three-dimensional polymer layer preferably has a thickness of about 1 nm to 100 μm, preferably of about 2 nm to about 10 μm, and particularly preferably of about 3 nm to about 100 nm. Furthermore, such a three-dimensional polymer layer is preferably porous. The monomeric or oligomeric building blocks are usually linked or coupled to functional groups, in particular to hydroxyl groups, of the three-dimensional polymer layer.

In a further preferred embodiment, the polymer layer on the support surface that is optionally modified is provided with a resist layer. The resist is preferably selected from photoresists, such as a positive resist, and phenol resins, such as Novolaken. Subsequently, the resist layer is usually removed substantially completely. For example, a polymer layer that has been modified with polyethylene glycol linkers, as previously described, is provided with a photosensitive resist, which is subsequently removed substantially completely by means of exposure and development. Surprisingly, it has been found that the properties of the polymer layer that remains on the support are advantageously altered by such a resist treatment, in particular in case the biopolymers synthesized on such a modified substrate serve as probe molecules in array experiments. It has thus been shown that the signal intensity is increased and the discrimination between match and mismatch probes is improved.

It is further preferred that the predetermined regions of the support are separated from one another by regions that are inert to the synthesis of biopolymers. Preferably, no synthesis of biopolymers can occur in said inert regions. By said pre-structuring the supports, the spatial resolution and thus the local specificity of the biopolymer synthesis is improved. With the use of the biopolymers that are synthesized in predetermined regions of a support or substrate in accordance with the present invention, said inert regions provide an exact measure of the background signal.

Separating the regions or spots on the support that are provided for the site-specific synthesis of the respective biopolymer species by inert regions is preferably achieved by means of the following embodiments of the methods according to the present invention.

Thus, the spots can, for example, be separated from one another by metallic regions on the support that are inert to the attachment of monomers. Basically, all subgroup metals and alloys thereof can be utilized as material for such inert regions. The materials for inert regions are preferably selected from metals such as titanium, gold, nickel, chromium and alloys of the previously mentioned metals, such as nickel-chromium. For generating the metallic boundaries between the predetermined regions, a metal layer can, for example, be applied onto the support surface by means of sputtering and subsequently structured according to a predetermined pattern. Structuring can, for example, be performed by means of photolithography and subsequent etching according to a predetermined pattern. The metal layer or the metallic inert regions on the support preferably have a thickness of about 50 nm to 150 nm and particularly preferably of about 100 nm.

In a further embodiment of the present invention, inert regions for separating the regions on the support that are predetermined for the synthesis of the respective biopolymer species can be provided by removing the functional groups that are provided for linking the monomeric building blocks on the support surface or the polymer layer that is attached to the support. Selective removal of, for example, the polymer layer that is optionally attached to the support and is optionally modified leads to regions on the support in which substantially no functional groups or no reactive groups are present and thus biopolymer synthesis is not possible.

In this embodiment, functional groups or linkers or polymer layers that are present on the support surface are preferably removed by etching, such as plasma etching. To this end, the support, which is derivatized with a polymer layer as previously described, can be coated with a photoresist. By arranging a mask, particularly a lithography mask, on the support and subsequent exposure, the exposed regions of the resist are detached in a subsequent development process in case a positive resist is employed. In this manner, the polymer layer is removed in defined regions which are supposed to form the inert regions, for example by means of using argon or O₂ plasma, while those regions of the functional polymer layer that have been covered by the mask beforehand are protected by undeveloped photoresist. Subsequently, the undeveloped protecting resist layer is detached from the functional polymer layer by means of further exposure and subsequent development. Thus, a structure can be generated that is homogeneous over the support and has functional polymer pads having a layer thickness of preferably about 1 nm to about 10 nm, particularly preferably about 2 nm to 7 nm, and most preferably 3 to 5 nm, for example about 4 nm. The polymer pads correspond to the predetermined regions and have functional groups for linking the monomeric components of the biopolymers.

The method according to the present invention for the site-specific synthesis of biopolymers having a defined sequence in predetermined regions of a solid support usually comprises a cyclic sequence of process steps per incorporation of one monomer or oligomer, that is:
a) aligning, i.e. arranging a mask on the support or substrate,
b) activating or deprotecting,
c) separating or detaching the mask from the support or substrate, and
d) coupling of a monomeric or oligomeric building block with functional groups of the support or substrate surface or to the intermediate of the biopolymer chain already synthesized in the respective predetermined region.

Thus, per synthesis cycle one monomer or oligomer is applied to the predetermined regions of the support that are predefined by the mask.

In a next step, the temporary protecting groups of the building blocks that were the last to be coupled in the regions that are predetermined by the mask are removed by adding an aqueous solution of a deprotection reagent. The aqueous deprotection reagent flows through the channels or hollow spaces between mask and support so that the protecting groups in the regions not covered by the mask can be removed.

Subsequent to the deprotection reaction, the hollow spaces or channels are usually rinsed and dried.

Subsequent to the deprotection reaction, the mask is preferably detached or separated from the support or substrate. This can be achieved by means of a cut-off wheel, for example in form of a scalpel, which is moved in the plane between the support or the substrate and the mask in the direction towards the center of the support or the substrate. Owing to the force that is exerted by such wheels, mask and support or substrate can be separated from each other. Further embodiments for the process of detaching the mask from the support are obvious to the person skilled in the art.

In a next step of the method according to the present invention, the support or the substrate is contacted with a solution of a monomeric or oligomeric building block. Thereby, coupling of monomeric components or monomers to the functional groups of the support surface or of the intermediate of the biopolymer chain that have been released by the deprotection reaction will occur in those predetermined regions in which the protecting groups have been removed due to the previous deprotection. To this end, the support is, for example, transferred into a synthesis chamber or reaction chamber or cartridge that has openings through which the cartridge can be filled with the synthesis reagents to be used. Such a reaction chamber, which is optionally pressure-proof, is preferably connected with a conventional synthesis apparatus, so that it is possible to use a synthesis protocol that is conventional for coupling a monomer in the respective biopolymer synthesis. For the synthesis of DNA using the method according to the present invention, the synthesis apparatus ÄKTA by Amersham Bioscience (Freiburg, Germany) can be employed.

After linking a monomer or oligomer to functional groups on the support or at the intermediate of the biopolymer chain has been completed, the previously described steps of arranging the mask, deprotecting, optionally detaching the mask, and synthesis of further monomeric building blocks to the existing biopolymer chain can be repeated until the respective complete biopolymer having the desired sequence is synthesized in each of the predetermined regions of the support.

After completion of synthesis, the permanent protecting groups attached to the monomeric building blocks are usually cleaved, preferably by employing the standard conditions described for the respective protecting groups (see, inter alia, T. W. Greene, P. G. M. Wuts, “Protective Groups in Organic Synthesis” John Wiley & Sons INC, New York; H.-D. Jakubke, see above). For the synthesis of DNA, for example, the permanent protecting groups that are attached at the nucleobases can thus be removed by using an aqueous ammonia solution.

After completion of the synthesis protocol, the support with the biopolymers synthesized thereon is removed from the cartridge, rinsed and subsequently dried.

The optionally automated standard DNA synthesis usually comprises the steps of (i) cleaving off the temporary protecting groups, (ii) coupling the monomeric or oligomeric building block in the presence of an activator, (iii) capping the non-reacted hydroxyl functionalities of the substrate or the biopolymer chain intermediate, and (iv) oxidizing the phosphite to form phosphotriesters. The performance of these steps will be described exemplarily below.

Synthesis occurs usually in the opposite direction (inversely) to biosynthesis, from the 3′ end to the 5′ end. To this end, for example, oxalic acid or methanesulfonic acid are employed as reagents for cleaving off the commonly used dimethyltrityl (DMT) protecting group.

Coupling the monomeric or oligomeric building block, which for example is present in form of phosphoramidite (N,N-diisopropylaminophosphite), to the substrate occurs subsequently to activation using a weak acid, such as tetrazole. It has to be noted that by adding the acid the temporary protecting group DMT will not be cleaved off.

After rinsing the substrate, a capping step is performed in which the non-reacted hydroxyl groups are reacted to corresponding acetic ester derivatives using reagents such as pyridine, N-methylimidazole and acetanhydride. Subsequently, another rinsing step with solvents is performed.

In the fourth step, the resulting phosphite compound is reacted to or oxidized to the more stable phosphotriester, for example by using an aqueous iodine solution along with pyridine.

After rinsing, a new synthesis cycle starts with cleaving off the protecting groups, for example the DMT protecting groups.

After complete synthesis of the desired nucleic acid, the permanent protecting groups are usually removed. The yield of each synthesis step is preferably higher than 98%.

Furthermore, the performance of an optionally automated peptide synthesis within the scope of the present invention will be hereinafter described.

Analogously to the synthesis cycle of DNA, the first step in peptide synthesis usually is cleaving off the temporary protecting group. In the standard solid phase peptide synthesis (SPPS), the base-labile Fmoc protecting group is preferably employed as it can be read out using UV sensors due to its absorption spectrum and thus less aggressive deprotection reagents have to be used. Alternatively, employing an acid-labile Boc protecting group is also conceivable.

After rinsing the support with solvent, the respective amino acid component or the amino acid derivative as well as a coupling reagent, such as dicyclohexylcarbodiimide (DCC), O-benzotriazole-N,N,N′,N′-tetramethyl-uronium hexafluorophosphate (HBTU), hydroxylbenzotriazole (HOBt), as well as a base, such as 1,8-diazabicyclo[5.4.0]undec-7-ene (DBU), each in a surplus, are reacted with the support. After reaction is completed, the reaction chamber is usually rinsed.

Finally, analogously to the synthesis of nucleic acids, the non-reacted amino functionalities are blocked in a capping step by adding acetanhydride and base.

After rinsing the substrate with a solvent, a new reaction cycle is performed.

By selecting suitable reaction conditions known to the person skilled in the art, it is often possible to simultaneously remove all permanent protecting groups in the synthesis of peptides.

The method according to the present invention is particularly employed for manufacturing microarrays as previously described in which the biopolymers that are synthesized in situ in predetermined regions in accordance with the present invention serve as molecular probes.

In a further aspect of the present invention, a microarray having biopolymer probes immobilized in predetermined regions is provided in which the percentage P of biopolymers having the desired number M of monomers is characterized by the formula P=S^{M}, wherein S is the average yield of a coupling step, i.e. the yield of the coupling of a monomeric and/or oligomeric building block, and wherein the density of predetermined regions, for example, is at least 1,500 spots per cm² and the average yield S is at least 95%, preferably at least 96%, particularly preferably at least 98%, and most preferably at least 99%.

The microarrays according to the present invention preferably have a density of predetermined regions of at least 2,500 spots per cm², particularly preferably of at least 10,000 spots per cm², and most preferably of at least 25,000 up to a million spots per cm².

In preferred embodiments, the support surface, which is calculated from the side lengths of the support and which the density of the spots is related to, is at most 1 cm², at most 25 mm², at most 17.64 mm², at most 4 mm², at most 1 mm², or at most 100 μm².

A further aspect of the present invention relates to the use of aqueous solutions of deprotection reagents in the synthesis of biopolymers.

When performing deprotection reactions, protonizing the protecting groups in case of acid-labile protecting groups or deprotonizing in case of base-labile protecting groups plays an important role. When using acids or bases in solvents it has to be noted that the respective pK_{S} or pK_{B} values can vary considerably depending on the solvent. In particular, the pK_{S} or pK_{B} values in organic solvents differ substantially from those in aqueous systems. Within the scope of the present invention it has surprisingly been found that such deprotection reactions in the synthesis of biopolymers can also be performed with deprotection reagents in aqueous solution.

The following examples serve for illustrating the present invention and are not to be understood as limiting.

### EXAMPLES

### Example 1

### Deprotection Using a 10% Aqueous Solution of Oxalic Acid

a) Wafer Substrate

A glass wafer (BF 33 glass, Schott) having a thickness of 0.7 mm is employed.

b) Cleansing and Structuring

Cleansing the wafer is performed using a JTB-100 solution (tetramethylammonium hydroxide solution) according to the following protocol:

The wafer is pre-cleansed for 30 min in an ultrasonic bath in 10% Deconex, subsequently repeatedly rinsed with deionized water (DI water) and then incubated for 30 min at 70° C. in JTB 100 solution. The wafer is rinsed 6× with VE water and 1× with DI water and is subsequently dried on a wafer centrifuge at 3000 min⁻¹ for 1 min.

By means of sputtering, a titanium layer having a thickness of about 100 nm is applied onto the cleansed wafer. The titanium layer is structured using positive resist AZ 1514H and exposure through a corresponding mask. After structuring via a titanium etching bath (0.8% HF, 1.3% nitric acid), the active area of each array (about 2 mm) is surrounded by a continuous chain of square titanium structures having a side length of 32 μm. The photoresist is removed by using ALEG 625 and PRS 3000 (Mallinckrodt Baker, Griesheim, Germany).

The wafer is shortly wetted with DI water and is then etched in a tempered water bath (55° C.) using sodium hydroxide solution for 30 s at 50° C.

Subsequently, rinsing is performed as follows: 6×VE water (1 min in each case, while agitating the wafer in the holder); 2×5 min DI water.

Finally, the wafer is spun dry and baked in a drying chamber with circulating air.

c) Silanization

The wafers are arranged vertically in the PFA holder on the PTFE ring in a Rettberg tube and the tube is rinsed with argon. Consecutively, 1.8 l toluol (water-free) and 79 ml glycidoxypropyltrimethoxysilane are added under inert conditions. The reaction mixture is heated up to 80° C. in an oil bath. The setup is mixed by introducing argon via two titanium frits. After the target temperature has been reached, it is held for 3 h.

After removing the oil bath, the setup is cooled down to below 60° C. in about 40 min, wherein mixing with argon is continued.

After opening the tube, the wafer is rinsed 1× with toluol, 3× with methanol, 4× with acetone, and 1× with DI water. Subsequently, the wafer is dried on a wafer centrifuge.

d) Modification of the Silane Layers

150 ml ACN are provided in a glass flask with 7.8 ml PEG200 and 5.1 ml bisglycidyloxypropylmethane dissolved therein while being vigorously stirred. Then, 1.044 ml concentrated sulfuric acid are added under stirring, and the resulting mixture is immediately used. The epoxidized wafer is incubated in said solution for 35 min at 60° C. in a water bath (also while being stirred). Subsequently, it is removed from the solution, rinsed 3× with dimethylformamide, 2× with acetone, and 1× with ethanol, and dried in a centrifuge.

e) DNA Synthesis on the Wafer Surface

The DNA synthesis is performed in a synthesizer Oligopilot OPII (Amersham Pharmacia, Freiburg, Germany). A circular reaction cartridge made of stainless steel is employed into which the wafer is screwed so that the side where the synthesis occurs is facing the reaction chamber while the opposite side of the wafer is located outside the reaction cartridge.

A total of 397 array areas are arranged in 21 lines and 21 rows on the chip wafer. The synthesis starts with a series of coupling steps, in which the same base is coupled throughout the entire wafer. DMT-protected phosphoramidites are used as building blocks. The following bases are coupled consecutively: C, C, C, T, A, T, T, C, G.

After coupling of the last G, the DMT protecting groups are removed in a site-specific manner. To this end, a mask is used. The mask has 21 identical channel bundles each having four parallel channels having a width of 128 μm and a distance (channel center to channel center) of 512 μm. At first, the mask is aligned horizontally without shift.

Subsequently, the DMT protecting groups are removed in a site-specific manner by passing a 10% aqueous solution of oxalic acid through the channels via the application of a vacuum. In the individual channel bundles, the deprotection time is varied as follows:

### Variant 1: 2 min

### Variant 2: 5 min

### Variant 3: 10 min

### Variant 4: 20 min

### Variant 5: 30 min

Subsequently, the channels are rinsed with water, the mask is lifted and the chip wafer is incorporated into the synthesis cartridge. The cartridge is processed in the synthesizer. Then, a G is coupled without deprotecting the cartridge, so that a coupling of the G will only occur in those regions that have previously been deprotected by means of oxalic acid.

The chip wafer is removed again from the cartridge. Another site-specific deprotection is performed and a further G is coupled analogously to the preceding step, despite that the mask is aligned in a 90° clockwise angle. In this deprotection process, the incubation time for oxalic acid is also varied as described above.

Subsequent to the coupling, the chip wafer remains in the cartridge. Further coupling steps throughout the entire wafer surface are performed in the following order: A C C C T T T G. After the last coupling step, the wafer is removed from the cartridge.

In order to remove the permanent protecting groups from the bases, the wafer is incubated in a PFA screw-cap tube in a water bath for 35 min in 30 to 33% ammonia at 55° C., is then removed from the solution and is rinsed as follows:

1× with ammonia (28-30%)
1× with DI water
1× with VE water (flowing)
1× with DI water
1× with ethanol

Subsequently, the wafer is spun dry in a wafer centrifuge for 60 s at 3000 min⁻¹.

The wafer is then cut into 397 individual chips having a side length of 3.4×3.4 mm on a wafer saw.

Under the assumption that the deprotecting and coupling steps proceed completely, arrays that are composed of three different sequences will result from the procedural method described. In each case, said sequences are generated redundantly on the array in defined regions according to the pattern shown in FIG. 1.

Said sequences are:

| | |
|---|---|
| Match sequence (18 mer): | 3′CCCTATTCGGACCCTTTG 5′ |
| | (light-colored regions in FIG. 1) |
| G-deletion (17 mer): | 3′CCCTATTCGACCCTTTG5′ |
| | (dark regions in FIG. 1) |
| G-insertion (19 mer): | 3′ CCCTATTCGGGACCCTTTG 5′ |
| | (gray regions in FIG. 1) |

f) Hybridization

The hybridization target is a DNA fragment from the 16s rRNA gene derived of Corynebacterium glutamicum resulting from an asymmetrical PCR amplification. It is generated according to the following protocol:

A PCR reaction mix having the following composition is prepared:

### 1×PCR reaction buffer (Eppendorf, Hamburg, Germany)

200 nM forward primer 16sfD1 Cy3, having the fluorescence dye Cy3 (Amersham-Pharmacia, Freiburg, Germany) at its 5′-end
66 nM reverse primer 16s Ra
(sequence: 5′ TACCGTCACCATAAGGCTTCGTCCCTA 3′)
133 nM competitor 16s Ra 3′ NH₂
(sequence: 5′TACCGTCACCATAAGGCTTCGTCCCTA-NH₂ 3′)

The amino modification at the 3′-end is integrated into the molecule during the chemical synthesis of the oligonucleotide (3′-amino modifier C7, Glen Research Corp., Sterling, Va., USA).

### Sequence: 5′AGAGTTTGATCCTGGCTCAG3′)

### 200 μM dNTPs

0.05 unit/μl Taq polymerase (Eppendorf, Hamburg, Germany)
2 ng/μl chromosomal DNA Corynebacterium glutamicum

The total volume of each sample is 25 μl.

The reactions are performed according to the following temperature profile:

### Initial denaturation for 2 min at 95° C.

subsequently
25 cycles:
30 sec 95° C.
30 sec 60° C.
30 sec 72° C.

### Terminal elongation for 7 min at 72° C.

The PCR fragment is dissolved in a final concentration of about 5 nM in a hybridization buffer (6×SSPE/0.2% SDS). The solution is split into aliquots each having a volume of 65 μl in separate Eppendorf tubes (1.5 ml, Eppendorf, Hamburg, Germany). An array is placed into each of said reaction tubes. Altogether, four arrays of each deprotection variant are hybridized with the target in parallel reaction mixes.

The hybridization setups with the array are incubated for 5 min at 95° C., and then immediately for 1 h at 50° C.

Subsequently, the chips are washed 1× for 5 min in 500 μl 2×SSC/0.2% SDS, 2×SSC (in each case at 30° C.) and 0.2×SSC (at 20° C.) in a thermoshaker (Eppendorf, Hamburg, Germany) at 500 rpm. After removing the last rinsing solution, the arrays are dried in a vacuum.

g) Detection and Analysis of the Hybridization Signals:

Detecting the hybridization signals is performed using a fluorescence microscope by Zeiss (Zeiss, Jena, Germany). Excitation occurs in incident light with a white light source and a filter set suitable for cyanine 3. The signals are recorded by means of a CCD camera (PCO Sensicam, Kehlheim, Germany). Exposure time is 5000 ms.

In FIG. 2, the recordings for deprotection times of 2 min, 10 min, and 30 min are shown.

Image analysis is performed by using the image evaluation software Iconoclust (Clondiag, Jena, Germany). In order to determine the position and orientation of the arrays, the square 32 μm marker structures made of titanium, which have been applied previously, are employed.

The results are depicted in FIG. 3 in form of a bar diagram. The hybridization signal in those regions in which the match sequence is generated by complete coupling is shown to increase while increasing deprotection time from 2 to 20 min. A 30 min deprotection yields no further improvement as compared to a 20 min deprotection. In those regions where the G insertion is generated by complete coupling, an initial increase of the hybridization signal is observed when prolonging the deprotection time from 2 to 5 min. Afterwards, the signal decreases continuously. An optimal discrimination between match and both mutations is achieved at a deprotection time of at least 20 min.

### Example 2

### Influence of the Occupation Density on the Hybridization Signal

The wafer substrate that is employed in this example as well as the protocols for cleansing, structuring, silanizing, and generating the synthesis layer correspond to those of Example 1.

a) DNA Synthesis on the Wafer Surface:

The DNA synthesis is performed in a synthesizer Oligopilot OPII. DMT-protected phosphoramidites are used as building blocks. A circular reaction cartridge made of stainless steel is employed, into which the wafer is screwed so that the synthesis side faces the reaction chamber while the opposite side of the wafer is located outside the reaction cartridge. Said cartridge is fluidly connected with the synthesis machine.

The synthesis starts with a coupling step in which the same base (T) is coupled throughout the entire wafer.

Subsequently, the reactive groups on the surface are blocked to different extents in a site-specific manner. To this end, the surface is first deprotected in a site-specific manner using a mask, i.e. the DMT protecting groups are removed. Subsequently, a defined mixture of Fluorprime amidite and a base amidite are coupled. The Fluorprime amidite blocks further synthesis as it has no functional groups to which further bases can be coupled.

The fluidic mask that is used for deprotecting has 21 identical channel bundles each having four parallel channels having a width of 128 μm and a distance (channel center to channel center) of 512 μm. First the mask is aligned horizontally without shift. Subsequently, the site-specific removal of the DMT protecting groups is performed by passing drawing a solution of 10% oxalic acid in water through the channels using a vacuum. The deprotection time is 20 min.

Subsequently, the channels are rinsed with water, the mask is lifted, the chip wafer is mounted into the synthesis cartridge and the cartridge is connected with the synthesizer. Coupling of a mixture of 50% T-amidite and 50% Fluorprime amidite is performed. The total concentration of amidite is 0.1 M.

According to the same principle, seven further synthesis steps (steps 2 to 8) are performed with altered parameters. The mask employed, the total amidite concentration, the deprotection time and the coupling protocol are identical. The following table provides an overview of the parameters that are varied in the coupling steps:

TABLE 1

| Step | Rotation | Shift | % T-amidite | % Fluorprime |
|---|---|---|---|---|
| 1 | 0° | 0 μm | 50 | 50 |
| 2 | 0° | 128 μm | 10 | 90 |
| 3 | 0° | 256 μm | 100 | 0 |
| 4 | 0° | 384 μm | 0 | 100 |
| 5 | 90° | 0 μm | 50 | 50 |
| 6 | 90° | 128 μm | 10 | 90 |
| 7 | 90° | 256 μm | 100 | 0 |
| 8 | 90° | 384 μm | 0 | 100 |

Via the coupling steps described, the number of active groups available for further synthesis on the different array elements is reduced to different extents. Under the assumption that the coupling reactions proceed quantitatively, array elements are generated having 100%, 50%, 25%, 10%, 5%, and 0% of the original density of functional groups available for further synthesis.

During the further course of the synthesis, the wafer is mounted into the reaction cartridge and the latter is connected with the synthesizer (Äkta, Amersham-Pharmacia, Freiburg, Germany). The following bases are coupled throughout the entire wafer surface facing the reaction cartridge: T,C, C, C, T, A, T, T, C, G,G.

After coupling the last G, DMT protecting groups are removed in a site-specific manner. To this end, a fluidic mask is employed that covers one half of each array element and exposes the other half to the deprotection reagent, as described above. Deprotection is performed using 10% oxalic acid in water for 20 min.

Subsequently, the channels are rinsed with water, the mask is lifted, the chip wafer is mounted into the synthesis cartridge and the cartridge is connected with the synthesizer. Coupling of an A in the deprotected areas is performed. Thereby, a sequence that is perfectly complementary to the subsequently employed hybridization target is generated during the course of the synthesis in said regions, while a sequence having a 1-base deletion is generated in the remaining regions.

The further synthesis occurs in the reaction cartridge throughout the entire wafer area facing the reaction cartridge, as described above. The following bases are coupled one after the other: C, C, C, T, T, T, G.

After the last coupling step, the wafer is removed from the cartridge. In order to remove the permanent protecting groups, the wafer is incubated in a PFA screw-cap tube in a water bath for 35 min in 30 to 33% ammonia at 55° C., is then removed from the solution and rinsed as follows:

1× with ammonia (28-30%)
1× with DI water
1× with VE water (flowing)
1× with DI water
1× with ethanol

Finally, the wafer is spun dry in a wafer centrifuge for 60 s at 3000 min⁻¹ and is cut into 397 individual chips having a side length of 3.4×3.4 mm on a wafer saw.

b) Hybridization

The hybridization target is an oligonucleotide labeled with the dye Cy3, having a length of 18 bases and the following sequence: 5′Cy3-GGGATAAGCCTGGGAAAC-3′.

The oligonucleotide is dissolved in a final concentration of 10 nM in hybridization buffer (6×SSPE/0.2% SDS). The solution is split into aliquots each having a volume of 65 μl in separate Eppendorf tubes (1.5 ml, Eppendorf, Hamburg, Germany). An array is placed into each reaction tubes. Altogether, ten arrays are hybridized with the target in parallel setups.

The hybridization setups with the array were incubated for 5 min at 95° C., and then immediately for 1 h at 50° C.

Subsequently, the chips are washed 1× for 5 min in 500 μl 2×SSC/0.2% SDS, 2×SSC (in each case at 30° C.) and 0.2×SSC (at 20° C.) in a thermoshaker (Eppendorf, Hamburg, Germany) at 500 rpm. After removing the last rinsing solution, the arrays are dried in a vacuum.

c) Detection and Analysis of the Hybridization Signals

Detecting the hybridization signals is performed using a fluorescence microscope by Zeiss (Zeiss, Jena, Germany). Excitation occurs in incident light with a white light source and a filter set suitable for cyanine 3. The signals are recorded via a CCD camera (PCO Sensicam, Kehlheim, Germany). Exposure time is 5000 ms. Image analysis is performed using the image evaluation software Iconoclust (Clondiag, Jena, Germany). In order to determine the position and orientation of the arrays, the square 32 μm marker structures made of titanium, which have been applied previously, are employed.

The results are depicted in FIG. 4 in form of a bar diagram. In the regions with a theoretical occupation density of 100, 50 and 25% of the maximal occupation, an identical hybridization signal is measured. Obviously, the hybridization in this density range is not limited by the number of probes on the surface. At an occupation density of less than 25%, the hybridization signal decreases continuously.

### Example 3

### Influence of the Chain Length on the Hybridization Signal

The wafer substrate that is employed in this example as well as the protocols for cleansing, structuring, silanizing, and generating the synthesis layer correspond to those of Example 1.

a) DNA Synthesis on the Wafer Surface:

The DNA synthesis is performed in a synthesizer Oligopilot OPII. DMT-protected phosphoramidites are used as building blocks. A circular reaction cartridge made of stainless steel is employed into which the wafer is screwed so that the synthesis side faces the reaction chamber while the opposite side of the wafer is located outside the reaction cartridge. Said cartridge is fluidly connected with the synthesis machine.

The synthesis starts with a coupling step in which the same base (T) is coupled throughout the entire wafer.

The following coupling steps are performed in a site-specific manner. To this end, the surface is deprotected in a site-specific manner using a mask, i.e. the DMT protecting groups are removed. The fluidic mask that is employed for the deprotection comprises 21 identical channels having a width of 1024 μm. The distance between the channels (channel center to channel center) corresponds to the grid measure of the wafer (chip center to chip center).

First the mask is aligned horizontally without shift. Subsequently, the site-specific removal of the DMT protecting groups is performed by passing a solution of 10% oxalic acid in water through the channels using a vacuum. The deprotection time is 20 min.

Subsequently, the channels are rinsed with water, the mask is lifted, the chip wafer is incorporated into the synthesis cartridge and the cartridge is connected with the synthesis machine. Coupling of a T-amidite is performed. The amidite concentration is 0.1 M.

According to the same principle, seven further synthesis steps (steps 2 to 16) are performed with altered parameters. The mask employed, the total amidite concentration, the deprotection time and the coupling protocol are identical. The following table provides an overview of the parameters varied in the coupling steps:

TABLE 2

| Step | Rotation | Shift | Amidite |
|---|---|---|---|
| 1 | 0° | 0 μm | dT |
| 2 | 0° | 128 μm | dT |
| 3 | 0° | 256 μm | dT |
| 4 | 0° | 384 μm | dT |
| 5 | 0° | 512 μm | dT |
| 6 | 0° | 640 μm | dT |
| 7 | 0° | 768 μm | dT |
| 8 | 0° | 896 μm | dT |
| 9 | 90° | 0 μm | dT |
| 10 | 90° | 128 μm | dT |
| 11 | 90° | 256 μm | dT |
| 12 | 90° | 384 μm | dT |
| 13 | 90° | 512 μm | dT |
| 14 | 90° | 640 μm | dT |
| 15 | 90° | 768 μm | dT |
| 16 | 90° | 896 μm | dT |

Via the coupling steps described, arrays are generated in which the different array elements have been subjected to a different number of coupling steps, whereby T-oligomers having different chain lengths have been generated.

During the further course of synthesis, the wafer is mounted into the reaction cartridge and the latter is connected with the synthesizer (Äkta, Amersham-Pharmacia, Freiburg, Germany).

The following bases are coupled throughout the entire wafer surface facing the reaction cartridge: T, C, C, C, T, A, T, T, C, G,G.

After coupling the last G, DMT protecting groups are removed in a site-specific manner. To this end, as described above, a fluidic mask is employed comprising 21 identical channels each having eight parallel channels having a width of 128 μm and a distance (channel center to channel center) of 256 μm. The mask is aligned vertically (rotation by 90°) with a shift of 64 μm. Thereby, one half of each array element occupied by T-oligomers of a defined chain length is covered and the other half is exposed to the deprotection reagent. Deprotection is performed by using 10% oxalic acid in water for 20 min.

Subsequently, the channels are rinsed with water, the mask is lifted, the chip wafer is mounted into the synthesis cartridge and the cartridge is connected with the synthesizer. Coupling of an A in the deprotected areas is performed. Thereby, a sequence that is perfectly complementary to the subsequently employed hybridization target is generated during the course of the synthesis in said regions, while a sequence having a 1-base deletion is generated in the remaining regions.

The further synthesis occurs in the reaction cartridge throughout the entire wafer area facing the reaction cartridge, as described above. The following bases are coupled one after the other: C, C, C, T, T, T, G.

After the last coupling step, the wafer is removed from the cartridge. In order to remove the permanent protecting groups, the wafer is incubated in a PFA screw-cap tube in a water bath for 35 min in 30 to 33% ammonia at 55° C., is then removed from the solution and rinsed as follows:

1× with ammonia (28-30%)
1× with DI water
1× with VE water (flowing)
1× with DI water
1× with ethanol

Finally, the wafer is spun dry in a wafer centrifuge for 60 s at 3000 min⁻¹ and is cut into 397 individual chips having a side length of 3.4×3.4 mm on a wafer saw.

b) Hybridization

Either an oligonucleotide labeled with the dye Cy3 and having a length of 18 bases with the following sequence: 5′Cy3-GGGATAAGCCTGGGAAAC-3′, or the PCR fragment described in Example 1 are used as hybridization targets.

The oligonucleotide is dissolved in a final concentration of 10 nM and the PCR product is dissolved in a final concentration of about 5 nM in hybridization buffer (6×SSPE/0.2% SDS). The solution is split into aliquots each having a volume of 65 μl in separate Eppendorf tubes (1.5 ml, Eppendorf, Hamburg, Germany). An array is placed into each of said reaction tubes. Altogether, ten arrays are hybridized with the target in parallel setups.

The hybridization setups with the array were incubated for 5 min at 95° C., and then immediately for 1 h at 50° C.

Subsequently, the chips are washed 1× for 5 min in 500 μl 2×SSC/0.2% SDS, 2×SSC (in each case at 30° C.) and 0.2×SSC (at 20° C.) in a thermoshaker (Eppendorf, Hamburg, Germany) at 500 rpm. After removing the last rinsing solution, the arrays are dried in a vacuum.

c) Detection and Analysis of the Hybridization Signals

Detecting the hybridization signals is performed in a confocal slide reader (Scanarray 4000, Packard Biochip Technologies, Billerica, Mass., USA). The arrays were placed into an adapter that had the external dimensions of a slide. Excitation was performed via the laser provided in the device for detecting the dye Cy3. The settings for laser performance and photomultiplier are selected in such a way that the signals do not reach the saturation level.

Image analysis is performed using the image evaluation software Iconoclust (Clondiag, Jena, Germany). In order to determine the position and orientation of the arrays, the square 32 μm marker structures made of titanium, which have been applied previously, are employed.

The results are depicted in FIGS. 16 to 19. FIGS. 16 and 17 show the image of an array after hybridization with the described oligonucleotide (FIG. 16) or PCR fragment (FIG. 17). The summarized results of hybridization experiments with the oligonucleotide or PCR fragment as a target are summarized in the bar diagrams in FIG. 18 (oligonucleotide) or 19 (PCR fragment).

The results of the oligo hybridization show that the hybridization signal observed is substantially not influenced by the number of T-couplings that have been performed prior to the synthesis of the sequence complementary to the target.

In the hybridization with the PCR product, which has a chain length exceeding that of the oligonucleotide, the hybridization signal continuously increases with the number of T-couplings occurring prior to the synthesis of the region of the probe that is complementary to the target.

### Example 4

### Modification of a Glass Wafer for DNA Synthesis

a) Wafer Substrate

A glass wafer (BF 33 glass, Schott) having a thickness of 0.7 mm is employed.

b) Cleansing and Structuring

Cleansing the wafer occurs analogously to the protocol of Example 1. By means of sputtering, a NiCr layer having a thickness of about 100 nm is applied onto the cleansed wafer. The NiCr layer is structured by using positive resist AZ 1514H and exposure through a corresponding mask. After structuring via a NiCr etching bath, a mixture of ammonium cer-IV-nitrate and perchlorate in water, the active area of each array (about 2 mm) is surrounded by a continuous chain of square NiCr structures having a side length of 32 μm. The NiCr alloy is completely removed from the remaining wafer surface. The photoresist is removed via ALEG 625 (Mallinckrodt Baker, Griesheim, Germany).

The wafer is briefly wetted with DI water and is then etched in a tempered water bath (55° C.) with 5 M sodium hydroxide solution at 50° C. for 30 s. Subsequently, the following rinsing steps are performed: −6×VE water (1 min each, while moving wafer in holder) −2×5 min DI water. Finally, the wafer is spun dry and is tempered at 150° C. for 1 h in a drying chamber with circulating air.

c) Silanizing

Silanizing the wafer is performed analogously to Example 1.

d) Manufacturing the Synthesis Layer by Modifying the Silane Layers

The silanized wafer as well as 150 ml H₂O are provided in a PE beaker. Then, 1.044 ml concentrated sulfuric acid are added while being stirred and said mixture is tempered for 35 min at 35° C. Subsequently, the wafer is removed from said solution and is repeatedly rinsed with completely desalted water. Finally, the wafer is rinsed with ethanol and is dried in a centrifuge at 3000 rpm for 60 s.

e) DNA Synthesis on the Wafer Surface

The DNA synthesis is performed in a synthesizer Äkta (Amersham Pharmacia, Freiburg, Germany). In contrast to Example 1, a reaction cartridge made from PEEK is employed.

The synthesis starts with a coupling step in which the nucleotide cytidine is coupled to the entire wafer. After five further coupling steps using the amidite building blocks C, C, T, A and T to the entire wafer, the temporary DMT protecting group is subsequently cleaved off in a site-specific manner by means of a mask and a 10% aqueous solution of methanesulfonic acid.

The fluidic mask to be used for deprotection has 21 channels having a width of 2048 μm that differ in a diverse pattern of islands, i.e. regions that are covered by the mask. After a reaction time of 5 min, the channels are rinsed with water, the mask is lifted, the chip wafer is mounted into the synthesis cartridge and the cartridge is connected with the synthesis machine. Three synthesis steps with the building blocks T, C, and G are performed without respectively shifting the mask.

Finally, the amidites G, A, C, C, C, T, T, T and G are respectively coupled on the entire wafer. After the last coupling step, the wafer is removed from the cartridge and is transferred to a cartridge made of stainless steel that is filled with 30 to 33% ammonia. After 35 min incubation at 55° C., the wafer is removed and is rinsed with the following solutions:

1× with rinsing ammonia (28-30%)
1× with DI water
1× with VE water (flowing)
1× with DI water
1× with ethanol

Finally, the wafer is spun dry in a wafer centrifuge for 60 s at 3000 min⁻¹ and is cut into 397 individual chips having a side length of 3.4×3.4 mm on a wafer saw.

f) Hybridization

Target: hybridization target is an oligonucleotide that is labeled with the dye Cy3 and has a length of 18 bases with the sequence 5′Cy3-GGGATAAGCCTGGGAAAC-3′.

The protocol of the hybridization as well as detecting the hybridization signals is performed analogously to Example 1. Exposure time of the chips is 6000 ms.

Two different DNA oligomers having the sequences 3′CCCTATTCGGACCCTTT 5′ (18 mer) and 3′CCCTATGACCCTT 5′ (15 mer) are assembled on the chips. The corresponding deletion sequence is located at those places covered by the mask stamps and visible as dark areas. The match sequence is located on the remaining area of the chip.

### Example 5

### Determining the Synthesis Yield Using Aqueous Deprotection Reagents

In this example, a DNA having the sequence 3′-TCAAAGGGTCCGAATAGGG-5′ is assembled at CPG support material via solid phase synthesis. To this end, an Expedite 8905 synthesizer of PerSeptive Biosystems is employed. Determining the synthesis yield is performed according to the method of UV-metrically measuring the dimethoxytrityl cations, which is known to the person skilled in the art.

In order to compare the synthesis methods, the previously mentioned sequence is assembled in a scale of 0.2 μmol according to standard protocol using trichloroacetic acid (TCA), while the same sequence is synthesized in parallel by departing from the standard protocol with respect to the use of 10% aqueous methanesulfonic acid (MSA) as deprotection reagent. To this end, the synthesis cartridge is removed from the synthesizer after each synthesis step, rinsed with 0.5 ml 10% MSA solution and reacted with 0.5 ml 10% MSA for 5 minutes. Subsequently, the synthesis cartridge is rinsed with 6×1 ml H₂O and is blown with air. After 3× rinsing with 1 ml acetonitrile, the support material is dried for 10 minutes using dry argon. After re-incorporating the cartridge into the DNA synthesizer, it is rinsed 3× with 1 ml acetonitrile before continuing the synthesis cycle.

In order to be able to make a statement as to the coupling efficiency, the deprotection with each 1 ml of a 0.1 M p-toluol sulfonic acid solution in acetonitrile is performed after the 2^{nd} and the 11^{th} synthesis steps. Subsequently to deprotection, the deprotection reagent is diluted with 0.1 M p-toluol sulfonic acid in acetonitrile in a ratio of 1:40 and is measured photometrically in a UV device (Perkin Elmer Lambda 40) in a cuvette having a 1.0 cm light path at a wavelength of 498 nm (ε₄₉₈=70 000).

From the UV absorptions measured, the average yields per synthesis step are determined to be 98.4% in standard synthesis and 98.3% in case of the modified synthesis.

### Example 6

### Peptide Synthesis on Glass Wafer

In the following, a procedural instruction for peptide synthesis on a glass wafer is provided.

A total of 397 array areas are arranged in 21 lines and 21 rows on a chip wafer. Analogously to Example 1, the glass wafers are subjected to the standard procedure of glass cleansing and structuring. The subsequent silanization is performed under the same reaction conditions as in Example 1 using a 5.3% (v/v) solution of 3-aminopropyloxysilane in toluol. The silanized wafers have a contact angle of about 50°.

Subsequently, the wafers are individually reacted in a synthesis cartridge made of PEEK. First, Boc-glycine-OH is coupled to the wafer as linker molecule. To this end, a solution of 0.1 M Boc-gly-OH in dimethylformamide (DMF) and 0.1 M O-benzotriazolyl-N,N,N′,N′-tetramethyluronium tetrafluoroborate (TBTU) as well as 0.12 M hydroxybenzotriazole (HOBt) is used according to the HOBt/TBTU method of Knorr et al. (R. Knorr, A. Trzeciak, W. Bannwarth, D. Gillesen, Tetrahedron Lett. 1989, 30, 2340-2349). Subsequently, the pH value is set to 8.5 by adding the base N,N-diisopropylethylamine (DIPEA) and the reaction cartridge is slightly shaken. After 60 min, the wafer is removed from the synthesis cartridge and is rinsed with each 10 ml 2×DMF and 2×DMF: dichloromethane (DCM) 1:1.

On the basis of said synthesis layer, the further synthesis cycles for assembling the peptides occur. In general, side-chain protected amino acids are used, analogously to the established solid phase synthesis of peptides. The protecting groups are selected in such a way that they can be cleaved off at the end of the synthesis under conditions as mildly as possible and preferably without metal-mediated catalysis. The tert.-butyloxycarbonyl group serves as temporary protecting group.

In a first step, a channel mask according to the present invention is oriented on the wafer and 10% aqueous methanesulfonic acid is passed through the channels of the system formed by wafer and channel mask. After 10 min, the channels are rinsed with H₂O and the mask is lifted from the wafer. The wafer is rinsed with acetonitrile and dried. After incorporating the wafer into the synthesis cartridge, the wafer is covered and reacted with the coupling solution (see supra) of the next amino acid coupling step. After the synthesis is completed, the temporary and the permanent protecting groups are removed by employing protocols known to the person skilled in the art.

### FIGURES

FIG. 1: Illustration of the array employed in Example 1.

| | |
|---|---|
| Match sequence | 3′ CCCTATTCGGACCCTTTG 5′ |
| (18 mer): | (light-colored regions in FIG. 1) |
| G-deletion (17 mer): | 3′ CCCTATTCGACCCTTTG 5′ |
| | (dark regions in FIG. 1) |
| G-insertion (19 mer): | 3′ CCCTATTCGGGACCCTTTG 5′ |
| | (gray regions in FIG. 1) |

FIG. 2: Recording of the hybridization signals according to Example 1 for deprotection times of 2 min, 10 min and 30 min.

FIG. 3: Illustration of the dependency of the hybridization signal on the deprotection time.

FIG. 4: Illustration of the dependency of the hybridization signal on the occupation density of the array.

FIG. 5: Schematic illustration of the synthesis cycle.

FIG. 6: Illustration of an embodiment of the mask.

FIG. 7: Enlargement of a section of a mask.

FIG. 8: Illustration of a system formed by mask and support.

FIG. 9: Schematic illustration of the system formed by mask and support (a: empty, b: filled).

FIG. 10: Schematic illustration of the principle of the selective deprotection.

FIG. 11: Reaction diagram for applying a silane layer onto the support.

FIG. 12: Reaction diagram for modifying a 1-hydroxypropyl-(2′-hydroxy)-oxypropylsilane layer that is attached on the support by adding an acid.

FIG. 13a: Schematic illustration of a metallically structured surface. The white spots represent the polymer layer or synthesis layer.

FIG. 13b: Schematic illustration of a surface structured with oxygen plasma. The gray fields represent the polymer layer or synthesis layer.

FIG. 14: Schematic illustration of the generation of a mask.

FIG. 15: Photograph of the reaction chamber.

FIG. 16: Hybridization with 10 nM oligo target according to Example 3.

FIG. 17: Hybridization with about 5 nM PCR target according to Example 3.

FIG. 18: Signal of the hybridization with the oligonucleotide target depending on the number of T-coupling steps performed prior to the synthesis of the sequence that is complementary to the oligonucleotide (see Example 3).

The light-colored bars (match) correspond to the signal measured at the probes whose specific region exhibits perfect complementarity to the hybridization target. The dark bars (mismatch) show the signal measured at probes whose specific regions exhibit a deletion of one base.

FIG. 19: Signal of the hybridization with the PCR target depending on the number of T-coupling steps performed prior to the synthesis of the sequence that is complementary to the oligonucleotide (see Example 3).

The light-colored bars (match) correspond to the signal measured at the probes whose specific region exhibits total complementarity to the target region in the hybridization target. The dark bars (mismatch) show the signal measured at the probes whose specific regions exhibit a deletion of one base.

FIG. 20: Comparison of different mask geometries.

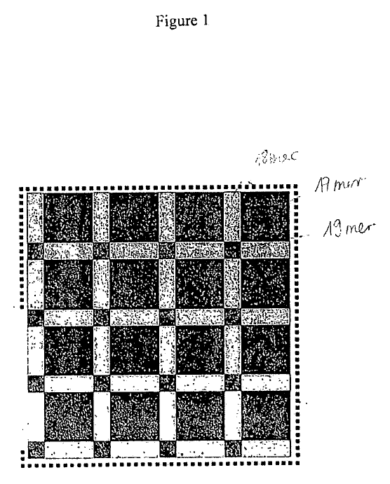

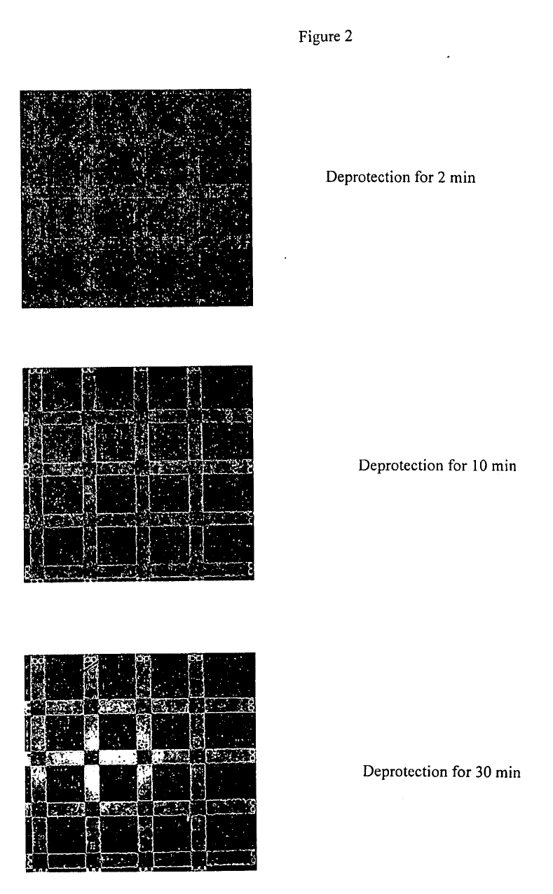

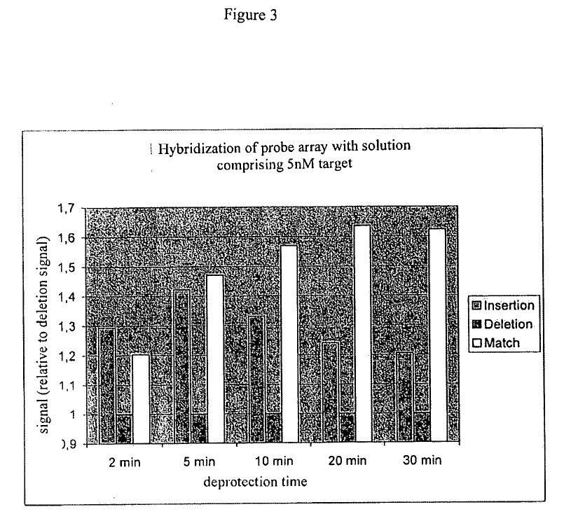

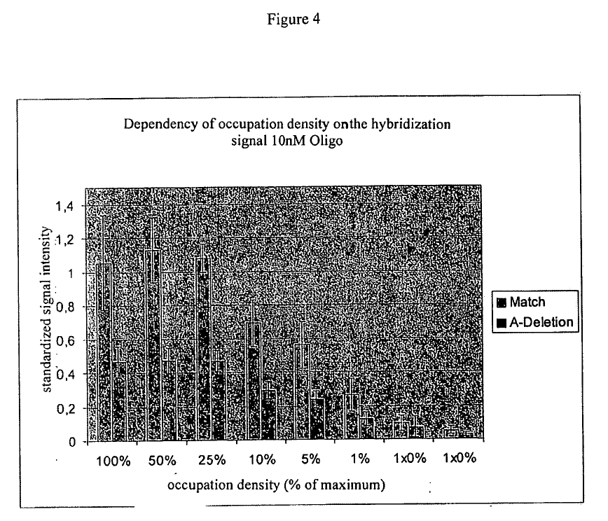

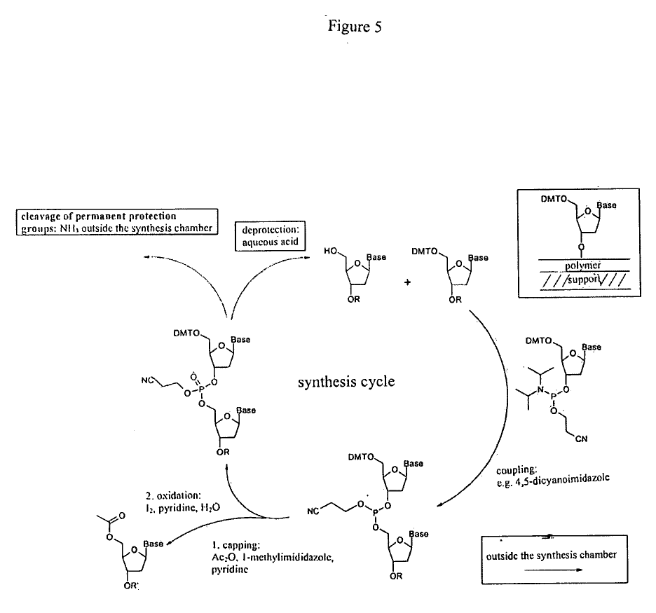

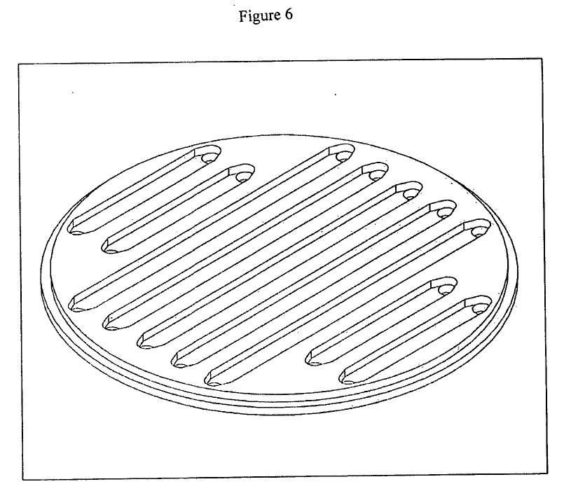

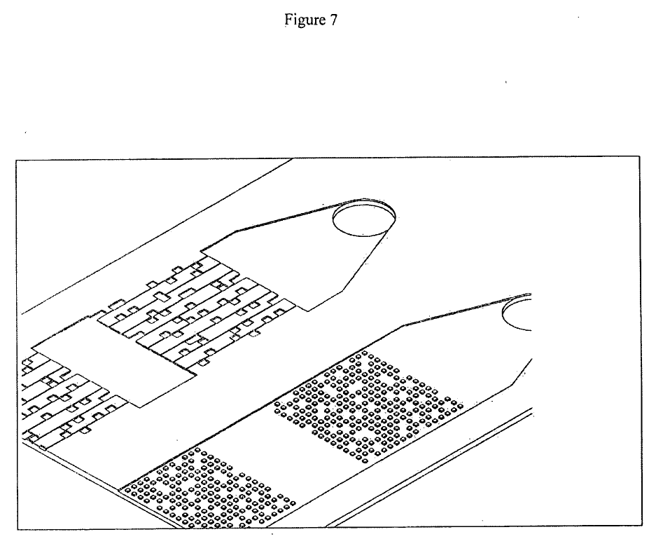

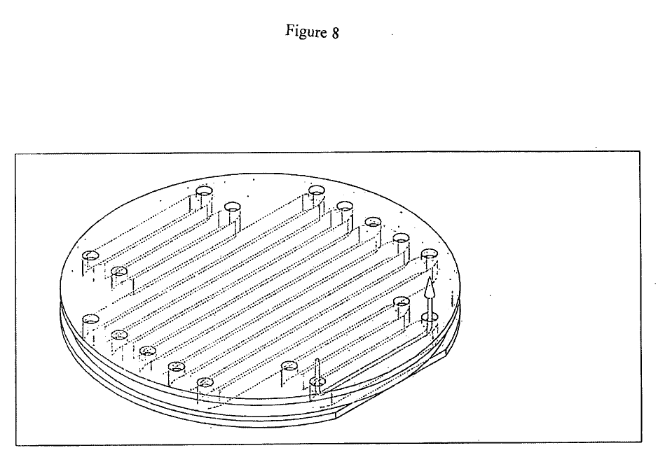

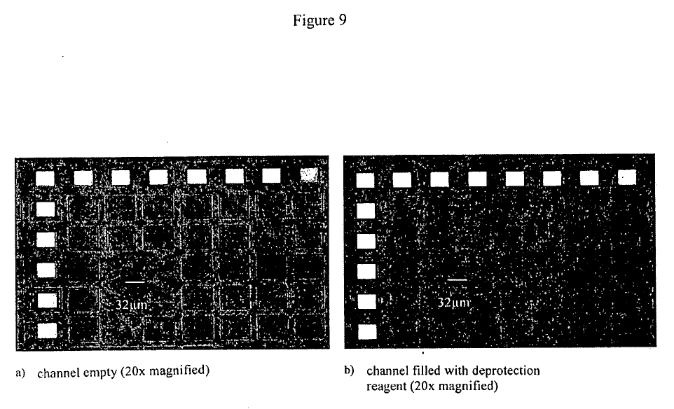

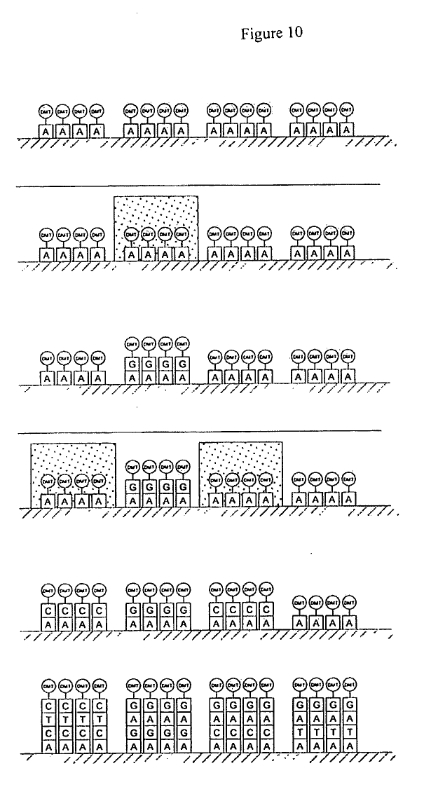

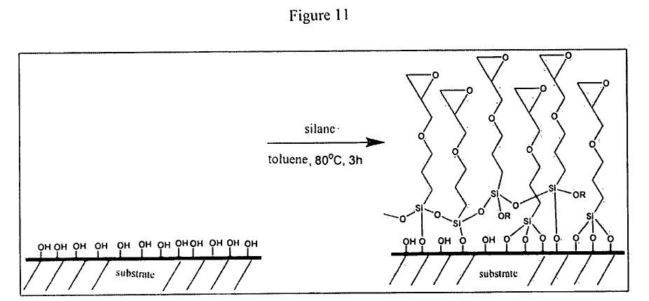

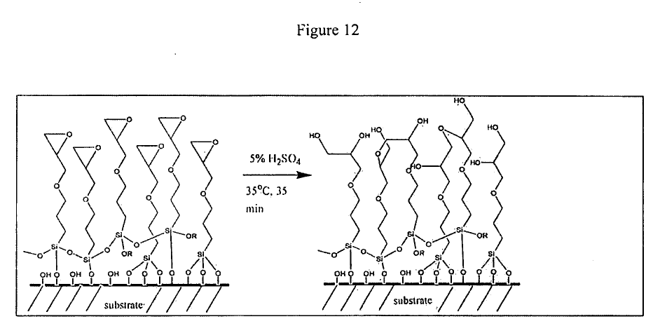

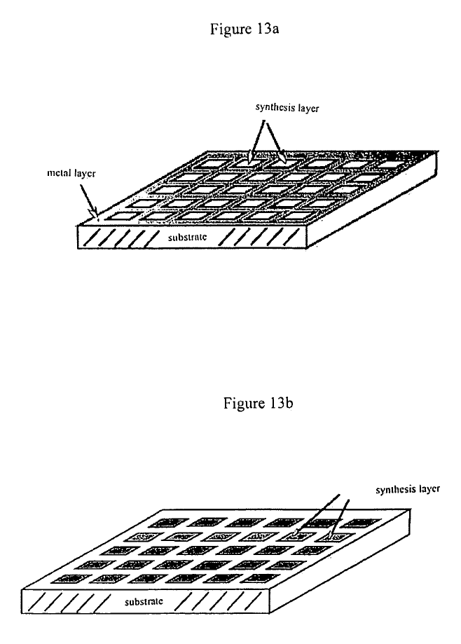

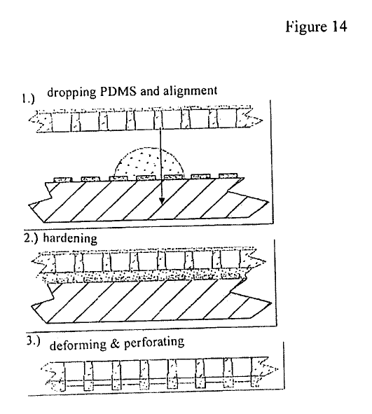

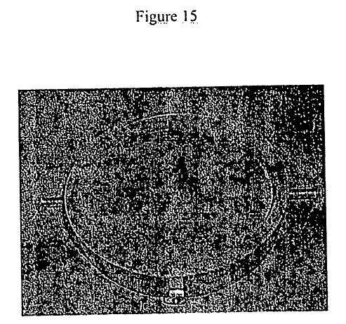

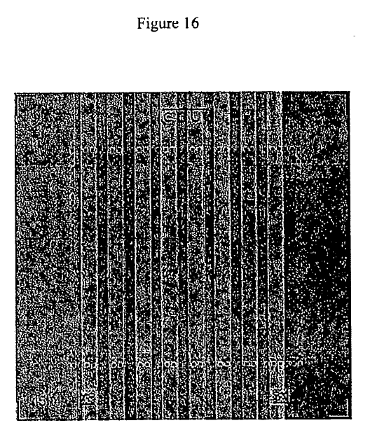

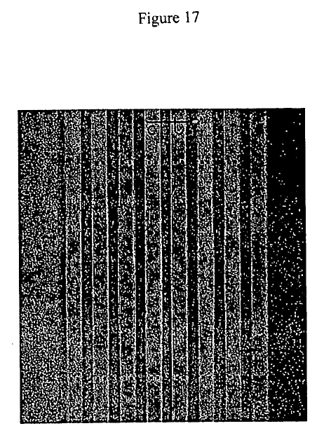

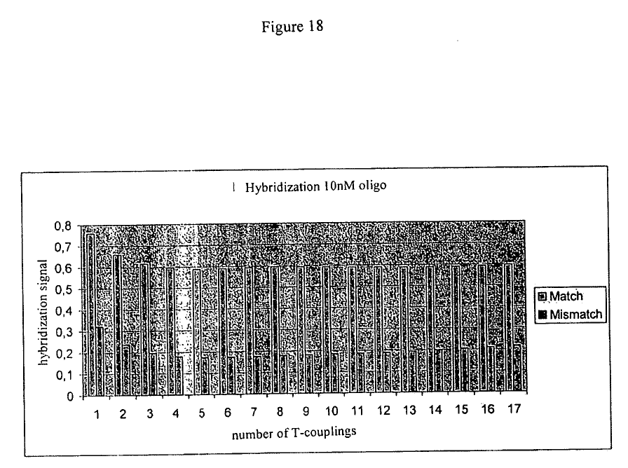

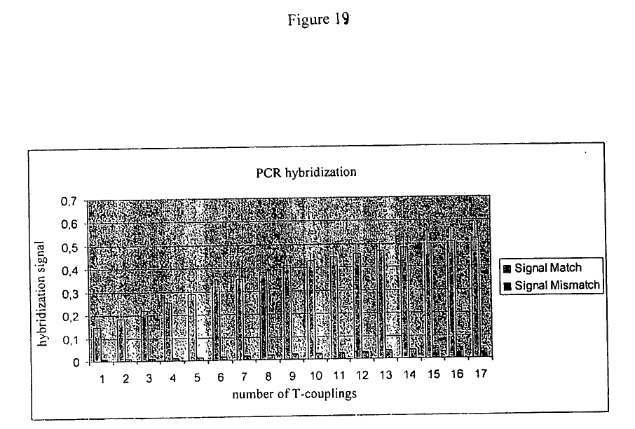

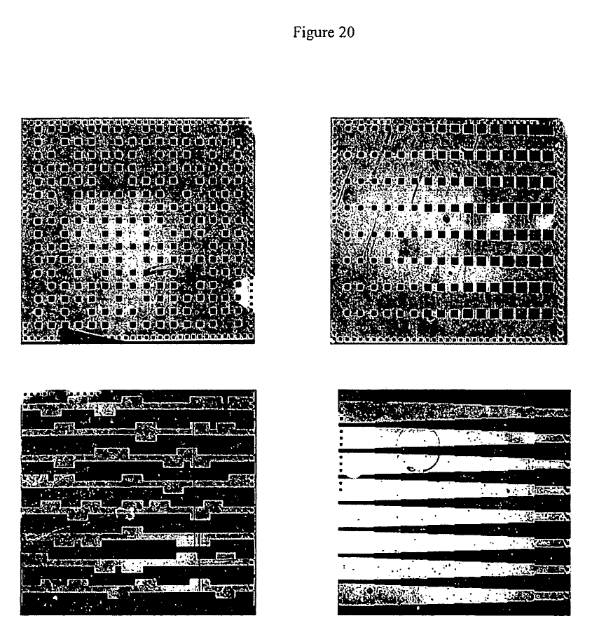

1. Method for the site-specific synthesis of biopolymers in predetermined regions of a solid support by the successive coupling of monomeric and/or oligomeric building blocks, the biopolymers having a defined sequence wherein prior to each coupling step reactive groups that are available in at least one predetermined region of the support for the coupling of a monomeric and/or oligomeric building block are activated in that temporary protecting groups are removed from said reactive groups by adding an activating reagent in aqueous solution.

2. Method according to claim 1,
wherein the temporary protecting groups are removed from such predetermined regions of the support that are predetermined by a mask that is arranged on the support.

3. Method according to any of the preceding claims,
wherein the support has reactive groups for the coupling of monomeric and/or oligomeric building blocks.

4. Method for the site-specific synthesis of biopolymers in predetermined regions of a solid support, the biopolymers having a defined sequence, comprising the following steps:
a) arranging a mask on the support, wherein reactive groups that are available on the support for the coupling of monomeric and/or oligomeric building blocks of the biopolymer to be synthesized are provided with protecting groups;
b) activating of reactive groups by removing of temporary protecting groups in the regions that are predetermined by the mask by adding an activating reagent in aqueous solution;
c) coupling of a monomeric and/or oligomeric building block to reactive groups that have been activated in step b); and
d) repeating the steps a) to c) until the desired biopolymers are synthesized in predetermined regions of the support.

5. Method according to any of the preceding claims,
wherein the mask is separated from the support prior to a coupling step.

6. Method according to any one of the preceding claims,
wherein the biopolymers are selected from nucleic acids, peptides, and peptide nucleic acids.

7. Method according to any of the preceding claims,
wherein the temporary protecting groups are selected from dimethyloxytrityl, tert.-butyloxycarbonyl and/or fluorenyl-9-methoxycarbonyl.

8. Method according to any of the preceding claims,
wherein the activating reagent is a deprotection reagent.

9. Method according to claim 8,
wherein the deprotection reagent is selected from oxalic acid, methanesulfonic acid, trifluoroacetic acid, hydrochloric acid and/or sodium hydroxide.

10. Method according to any of the preceding claims,
wherein the support is selected from silicon, silica, glass and/or ceramics.

11. Method according to any of claims 2 to 10,
wherein the mask that is arranged on the support adheres to the support.

12. Method according to any of claims 2 to 11,
wherein the mask comprises elastomers at least on the side that contacts the support.

13. Method according to claim 12,
wherein the elastomer is polydimethylsiloxane.

14. Method according to any of the preceding claims,
wherein the support has a rough surface.

15. Method according to any of the preceding claims,
wherein the predetermined regions are separated from one another by regions that are inert to the synthesis of biopolymers.

16. Method according to any of the preceding claims,
wherein the support has markings for arranging a mask on the support.

17. Method according to any of the preceding claims,
wherein the support comprises 50 to 65,000 predetermined regions.

18. Method according to any of the preceding claims,
wherein biopolymers that are synthesized in different predetermined regions differ with respect to their sequence.

19. Method according to any of the preceding claims,
wherein the surface of the support is 100 μm² to 1 cm² and preferably 3 mm² to 25 mm².

20. Method according to any of the preceding claims,
wherein the sequences of the biopolymers are selected according to their suitability as molecular probes in microarray experiments.

21. Use of a method according to any of claims 1 to 20 for manufacturing a microarray having biopolymer probes immobilized in predetermined regions.

22. Use of a method according to any of claims 1 to 20 for manufacturing a microarray having biopolymer probes immobilized in predetermined regions, wherein the predetermined regions are separated from one another by inert regions.

23. Microarray having biopolymer probes immobilized in predetermined regions, in which the percentage P of biopolymers that have the desired number M of monomers is characterized by the formula P=S^{M},
wherein S is the average yield of a coupling step of a monomeric and/or oligomeric building block,
and wherein the density of predetermined regions is at least 1,500 predetermined regions per cm² and the average yield S is at least 95%, preferably at least 96%, particularly preferably at least 97%, and most preferably at least 98%.

24. Microarray according to claim 22, manufactured by a method according to any of claims 1 to 20.

25. Use of deprotection reagents in aqueous solution in the synthesis of biopolymers for cleaving off temporary protecting groups.
